(19) United States
(12) Patent Application Publication
(10) Pub. No.: US 2010/0071868 A1
(43) Pub. Date: Mar. 25, 2010

(54) HVAC UNITS, HEAT EXCHANGERS, BUILDINGS, AND METHODS HAVING SLANTED FINS TO SHED CONDENSATION OR FOR IMPROVED AIR FLOW

(75) Inventors: ALLAN J. REIFEL, Florissant, MO (US); Russell W. Hoeffken, Millstadt, IL (US)

Correspondence Address: BRYAN CAVE LLP, TWO NORTH CENTRAL AVENUE, SUITE 2200, PHOENIX, AZ, 85004, US

(73) Assignee: NORDYNE Inc., O'Fallon, MO (US)

(21) Appl. No.: 12/561,178

(22) Filed: Sep. 16, 2009

Related U.S. Application Data
(60) Provisional application No. 61/098,523, filed on Sep. 19, 2008.
(60) Provisional application No. 61/174,369, filed on Apr. 30, 2009.

(51) Int. Cl. F24H 3/00; F28F 9/02; F28F 1/10; B23P 15/26

(52) U.S. Cl. 165/47; 165/173; 165/181; 29/726

(57) ABSTRACT

HVAC units and systems, air conditioning units, and heat pumps that have micro-channel heat exchangers wherein fins are slanted, multi-tubes are oriented non-horizontally (e.g., vertically), or both, for example. Fins may be slanted downward in the direction of air flow to facilitate drainage of condensation, or may be slanted either downward or upward as appropriate to reduce air-flow restriction. Other embodiments include the heat exchangers themselves and buildings having such heat exchangers, units, or systems, as well as methods concerning such devices, such as methods of manufacture. In some embodiments, heat exchangers are used as evaporators in air conditioning units, as condensers in heat pumps, or both, as examples.

### RELATED PATENT APPLICATIONS

This non-provisional utility patent application claims priority to and incorporates by reference provisional patent applications Ser. Nos. 61/098,523, filed on Sep. 19, 2008, titled: HVAC UNITS, HEAT EXCHANGERS AND METHODS HAVING SLANTED FINS TO SHED CONDENSATION, and 61/174,369, filed on Apr. 30, 2009, titled: HVAC UNITS, HEAT EXCHANGERS AND METHODS HAVING SLANTED FINS FOR IMPROVED AIRFLOW, both naming the same two inventors, Allan J. Reifel and Russell W. Hoeffken.

### FIELD OF THE INVENTION

This invention relates to air conditioning units, heat pumps, and heat exchangers, including heat exchangers used in air conditioning units and heat pumps for buildings, to methods of making heat exchangers, air conditioning units, and heat pumps, and to buildings having such equipment.

### BACKGROUND OF THE INVENTION

Heat exchangers have been used for some time to transfer heat from a warmer fluid to a cooler fluid, including in air conditioning units and heating ventilating and air conditioning (HVAC) units for cooling or heating (or both) air delivered to spaces that people occupy, such as within buildings, vehicles, or the like. Heat exchangers have been used to serve as evaporators and condensers in air conditioning units and heat pumps, for example, to transfer heat between a refrigerant and air, for instance. In many heat exchangers, header tubes have been used as conduits for a working fluid, such as a refrigerant, which may be liquid, gas, or a combination thereof. Smaller tubes have extended between header tubes, and these smaller tubes have been bonded to fins, external to the smaller tubes, to enhance heat transfer to the air, for example.

Micro-channel heat exchangers have been used in the prior art in particular applications where condensation from the air and icing of the heat exchanger was not a concern. Micro-channel heat exchangers typically have had multiple small contiguous passageways within the smaller tubes extending between the header tubes, and fins have been bonded to these “multi-tubes”, for example, between the multi-tubes. Micro-channel heat exchangers have been used successfully as condensers in air conditioning units that were not heat pumps, for example. Rather, micro-channel heat exchangers have been efficient and cost effective in applications where condensation was not of concern.

Micro-channel coil designs have increasingly been employed in residential and commercial air conditioning condenser coil applications due to their superior performance and cost effectiveness when compared to conventional tube-fin coils, for example. Thus far, however, micro-channel coil designs have only been successfully applied to air conditioner condenser coils which are not required to handle condensate water. Micro-channel coil's inability to drain condensate properly has prevented their use in evaporator coils and heat pump condenser coils, which function as evaporators during operation in the heating mode.

In prior art micro-channel heat exchangers used in air conditioning systems, the header tubes were typically oriented vertically in the unit at the sides of the heat exchanger, and the multi-tubes were oriented horizontally. This configuration worked well for condensers, where the refrigerant was warmer than the air and condensation of moisture from the air was not of concern. But micro-channel heat exchangers were not well suited for use as evaporators in the past, because condensation forming on them tended to remain in place on the fins, multi-tubes, or both. At least under certain conditions, this condensation would freeze, blocking the air-flow passageways. As a result, despite disadvantages, other types of heat exchangers besides micro-channel heat exchangers were used as evaporators in air conditioning units and as heat exchanges that are used as evaporators in either mode of operation (i.e., heating or cooling) in heat pumps.

In the typical construction of micro-channel coils, the fins were folded in an accordion fashion from strip stock and brazed between micro-channels at right angles to the channels, parallel to the rows of passageways in the micro-channels. The fins transferred heat to, or from, an air stream flowing at right angles to the micro-channels. While micro-channel heat exchangers have performed well as dry coils, they have not permitted the drainage of condensate when wet as they have tended to “hold” the condensate in place. This problem was exacerbated in heat pumps where defrosting and drainage of the water is required at certain intervals to prevent ice build-up.

Needs or potential for benefit or improvement exist for micro-channel heat exchangers that are suitable for use as evaporators in HVAC systems or units, for example. Further, needs or potential for benefit or improvement exist for micro-channel heat exchangers that more-effectively clear condensation, prevent ice build-up, or both, as examples. Needs or potential for benefit or improvement exist for micro-channel heat exchangers that are inexpensive, can be readily manufactured, that are easy to install, that are reliable, that have a long life, or a combination thereof, as examples. In addition, needs or potential for benefit or improvement exist for air conditioning units and heat pumps having micro-channel heat exchangers used for evaporators that drain condensation in an improved manner, as well as buildings having such units. Further, needs or potential for benefit or improvement exist for methods of manufacturing such micro-channel heat exchangers and HVAC units using micro-channel heat exchangers as evaporators.

In addition, heat exchangers have been used and oriented in applications where the predominant air-flow direction approaching or leaving the heat exchanger was not parallel to the fins within the heat exchanger, or wherein the predominant air-flow direction approaching or leaving the heat exchanger was not perpendicular to the row or rows of passageways through multi-tubes. Examples include HVAC applications wherein fins were perpendicular to the heat exchanger, but the heat exchanger was not positioned perpendicularly to the predominant air-flow direction approaching or after leaving the heat exchanger.

In such applications, the air must turn at an angle in order to pass through the heat exchanger and flow parallel to the fins or rows, after passing through the heat exchanger, or both. In many instances, one or both of these angles have been significant. The resulting abrupt change in direction of flow before or after (or both) the heat exchanger has resulted in turbulence and pressure drop that typically must be overcome with fan energy and that may result in noise, vibration, or both.

As an example, heat exchangers have been used and oriented with vertical headers, horizontal parallel tubes or micro-tubes and vertical fins between the parallel or micro-tubes. Air has been exhausted upwards from air conditioning condensers (e.g., in split systems) and has passed through the condenser heat exchanger predominantly horizontally, before turning 90 degrees to be exhausted vertically (e.g., through an axial-flow fan). This change in direction results in turbulence and pressure drop that must be overcome by the condenser fan. It would be desirable and beneficial to reduce this pressure drop.

Accordingly, needs or potential for benefit exist for reducing pressure drop resulting from abrupt changes in air-flow direction at the entrance to or after leaving heat exchangers (or both), reducing noise, reducing vibration, requiring less fan energy, requiring a less powerful fan, and the like. Further, needs or potential for benefit or improvement exist for (e.g., micro-channel) heat exchangers that provide for improved air flow or reduced air-flow restriction and that are inexpensive, can be readily manufactured, that are easy to install, that are reliable, that have a long life, or a combination thereof, as examples. In addition, needs or potential for benefit or improvement exist for HVAC units having such (e.g., micro-channel) heat exchangers, as well as buildings having such units and methods of making such HVAC units.

Other needs or potential for benefit or improvement may also be described herein or known in the HVAC industry. Room for improvement exists over the prior art in these and other areas that may be apparent to a person of ordinary skill in the art having studied this document.

### BRIEF DESCRIPTION OF THE DRAWINGS

FIG. 1 is an isometric view of part of a heat exchanger that has slanted fins located between vertical multi-tubes;

FIG. 2 is the isometric view of the part of the heat exchanger of FIG. 1 but showing only one column of slanted fins and only one multi-tube;

FIG. 3 is a cross-sectional end view of the part of the heat exchanger of FIG. 1 and FIG. 2, showing a cross section through the slanted fins;

FIG. 4 is a close-up isometric view of part of one column of fins and one vertical multi-tube, which is similar to the top of FIG. 2, except that in FIG. 4, the fins have been enhanced with multiple louvers;

FIG. 5 is a close-up cross-sectional end view taken through the fins of FIG. 4, similar to the top of FIG. 3 except that the embodiment of FIG. 5 has louvers and the embodiment of FIG. 3 does not;

FIG. 6 is a close-up, top, cross-sectional view of part of the heat exchanger of FIG. 4 and FIG. 5 showing, among other things, multiple contiguous passageways through the multi-tubes that are arranged in one row per multi-tube (a close-up, top, cross-sectional view of part of the heat exchanger of FIG. 1 to FIG. 3 may be similar except lacking the louvers);

FIG. 7 is a top view of a flat piece of sheet metal showing where the sheet metal can be bent to form the fins of FIG. 4, and showing the louvers formed in three of the fins (a top view of a flat piece for the fins of the embodiment of FIG. 1 to FIG. 3 may be similar except lacking the louvers);

FIG. 8 is an isometric view of part of a heat exchanger that also has slanted fins located between vertical multi-tubes, this view showing only one column of slanted fins and only one multi-tube, this embodiment having fins that are slanted more steeply than the embodiments of FIG. 1 to FIG. 7;

FIG. 8a is an isometric view of part of a heat exchanger that also has slanted fins located between vertical multi-tubes, showing multiple columns of slanted fins and multiple multi-tubes, this embodiment having multi-tubes that extend beyond the fins on one side of the heat exchanger, for example, to promote runoff of condensation;

FIG. 9 is a cross-sectional end view of part an embodiment of a heat exchanger, showing, among other things, various angles and air-flow directions described herein;

FIG. 10 is a end view (with the end cover removed) of two heat exchangers within a heat exchanger assembly showing the air flow upward through the heat exchangers;

FIG. 11 is an exploded isometric view of the heat exchanger assembly of FIG. 10 that includes two heat exchangers, also showing the air flow upward through the heat exchangers;

FIG. 12 is an isometric assembly view of the heat exchanger assembly of FIG. 10 and FIG. 11;

FIG. 13 is an isometric assembly view of an HVAC unit which may contain inside the heat exchanger assembly of FIG. 10 to FIG. 12;

FIG. 14 is a end view (with the doors and end cover removed) of the HVAC unit of FIG. 13 showing therein the two heat exchangers and heat exchanger assembly of FIG. 10 to FIG. 12;

FIG. 15 is a side view (with the doors removed) of the HVAC unit of FIG. 13 and FIG. 14 showing therein one of the two heat exchangers of FIG. 10 to FIG. 12;

FIG. 16 is a cross-sectional elevation view of a building having a split-system HVAC unit; and

FIG. 17 is a flow chart illustrating various examples of methods of making an HVAC unit, for instance.

The drawings illustrate, among other things, various examples of embodiments of the invention, and certain examples of characteristics thereof. Different embodiments of the invention may include various combinations of elements or acts shown in the drawings, described herein, known in the art, or a combination thereof, for instance. Other embodiments may differ.

### SUMMARY OF PARTICULAR EMBODIMENTS OF THE INVENTION

This invention provides, among other things, heat exchangers having angled or slanted fins, louvers, or both, and heat exchangers with non-horizontal or vertical multi-tubes, both of which, either alone or in combination, may drain condensation better than prior art multi-channel heat exchangers, for example. Certain embodiments are or include HVAC units, air conditioning units, and heat pumps having, for instance, multi-channel heat exchangers used as evaporators, buildings having such units or heat exchangers, and methods of manufacturing such products, as examples. In addition, this invention provides heat exchangers having angled or slanted fins that are used to improve air flow through the heat exchanger (e.g., in HVAC units), HVAC units having such heat exchangers, methods of making an HVAC unit having reduced air flow restriction, and buildings having such units, as examples.

Various embodiments provide, for example, as an object or benefit, that they partially or fully address or satisfy one or more of the needs, potential areas for benefit, or opportunities for improvement described herein, or known in the art, as examples. Certain embodiments provide, for example, micro-channel heat exchangers that are suitable for use as evaporators in HVAC systems or units, for example. Particular embodiments provide micro-channel heat exchangers that more-effectively clear condensation, prevent ice build-up, or both, as examples. Further, various embodiments provide, for example, HVAC units that utilize (e.g., micro-channel) heat exchangers that provide less restriction to air flow in the configuration used than prior art alternatives. In some embodiments, heat exchangers having angled fins allow the heat exchangers to be arranged or oriented differently (e.g., within an HVAC unit) providing for better space utilization, alternate styling, less air-flow restriction, less noise, less vibration, or a combination thereof, as examples. In a number of embodiments, reductions in air-flow restriction save energy, allow use of smaller fans or fan motors, reduce noise, or a combination thereof, for instance. Even further, certain embodiments provide for micro-channel heat exchangers that are inexpensive, can be readily manufactured, that are easy to install, that are reliable, that have a long life, or a combination thereof, as examples.

Specific embodiments of the invention include various HVAC units, and buildings having HVAC units, as examples. In a number of embodiments, at least one heat exchanger in the HVAC unit has a predominant air-flow direction, and includes a first refrigerant header tube, a second refrigerant header tube, and multiple parallel multi-tubes extending from the first refrigerant header tube to the second refrigerant header tube, for example. In a number of embodiments, the multi-tubes may be parallel to each other geometrically, arranged in parallel with respect to flow of the refrigerant, or both, as examples. Further, each multi-tube may have, for example, multiple contiguous parallel refrigerant passageways therethrough, which may be arranged in at least one row, for instance. Further, in many embodiments, each heat exchanger module includes multiple fins between the multi-tubes. The fins may be bonded to the multi-tubes, for instance, and the multi-tubes may be oriented non-horizontally in the HVAC unit, for example, with the fins slanted (e.g., from horizontal).

In certain embodiments, the multi-tubes may be oriented at an angle that is closer to vertical than to horizontal, or may be oriented substantially vertically, as examples. Further, in some embodiments, multiple of the fins may include multiple louvers, and the louvers may be slanted, for example. Moreover, the HVAC unit may include, in various embodiments, at least two heat exchangers, each heat exchanger having, for example, a first refrigerant header tube and a second refrigerant header tube, and multiple parallel multi-tubes extending from the first refrigerant header tube to the second refrigerant header tube, for instance. In particular embodiments, in both heat exchangers, the multi-tubes may be parallel to each other geometrically, arranged in parallel with respect to the flow of the refrigerant, or both, and each multi-tube may have, for example, multiple contiguous parallel refrigerant passageways therethrough arranged in at least one row.

In some embodiments, the fins may be slanted downward in the air-flow direction, for example, to promote condensation run off from the fins. In certain embodiments, the HVAC unit may be a heat pump, for example, and facilitating runoff of condensation may allow the use of micro-channel heat exchangers (e.g., as evaporators). On the other hand, in other embodiments, the fins may be slanted (e.g., either downward or upward in the air-flow direction), for example, to reduce air-flow restriction (e.g., fins may be slanted upward where the predominant air-flow direction approaching or leaving the heat exchanger has an upward component), for instance. Further, in some embodiments, some or all of the multi-tubes may extend beyond the fins on at least one side of the heat exchanger to promote runoff of condensation.

Other specific embodiments include various heat exchangers, for example, for transferring heat from air that may contain moisture, to a working fluid. In various embodiments, such heat exchangers may include a first working fluid header tube, a second working fluid header tube, and multiple parallel multi-tubes extending from the first working fluid header tube to the second working fluid header tube, for example. As in other embodiments, the multi-tubes may be parallel to each other geometrically, arranged in parallel with respect to flow of the working fluid, or both. And in many embodiments, each multi-tube may have, for example, multiple contiguous parallel working fluid passageways therethrough, which may be arranged in at least one row, for example. In various embodiments, there may be multiple fins between the multi-tubes, which may be bonded to the multi-tubes, and the fins may be oriented at an angle between 45 and 80 degrees from the multi-tubes, for example.

Other embodiments include various HVAC units that include such heat exchangers. In particular embodiments, such HVAC units may have, for example, a predominant air-flow direction approaching the heat exchanger and the heat exchanger may have a perpendicular direction that may be perpendicular to the first header tube, perpendicular to the second header tube, perpendicular to the multi-tubes, or a combination thereof, for example. In a number of embodiments, a first angle may exist between the predominant air-flow direction approaching the heat exchanger and the fins, and this first angle may be less than a second angle between the predominant air-flow direction approaching the heat exchanger and the perpendicular direction, for example. Further, in certain embodiments, the fins may be oriented at a third angle from the multi-tubes, and the third angle plus the second angle minus the first angle may be substantially equal to 90 degrees, for instance. Moreover, in some embodiments, an HVAC unit may have, for example, a predominant air-flow direction after leaving the heat exchanger, and a fourth angle between the predominant air-flow direction after leaving the heat exchanger and the fins may be less than a fifth angle between the predominant air-flow direction after leaving the heat exchanger and the perpendicular direction.

Still other specific embodiments include various methods, for instance, of making an HVAC unit that may have, for example, reduced air flow restriction. Such methods may include, in various embodiments, in various sequences, at least certain acts. Such acts may include, for instance, obtaining or providing a heat exchanger that may have, for example, fins oriented at a non-zero fin angle to a perpendicular direction (e.g., perpendicular to the heat exchanger). Other acts that may be found in such methods may involve mounting the heat exchanger within the HVAC unit in the path of air flow approaching the heat exchanger, and positioning the heat exchanger so that a first angle between the predominant air-flow direction approaching the heat exchanger and the fins is less than a second angle between the predominant air-flow direction approaching the heat exchanger and the perpendicular direction.

In a number of embodiments, the act of obtaining or providing the heat exchanger may include obtaining or providing a heat exchanger having a first header tube and a second header tube, and the perpendicular direction may be perpendicular to the first header tube, perpendicular to the second header tube, or both, as examples. Further, in some embodiments, the act of obtaining or providing the heat exchanger may include obtaining or providing a heat exchanger having, for example, multiple parallel tubes extending from the first header tube to the second header tube. In some embodiments, the perpendicular direction may be perpendicular to the parallel tubes, for instance. Moreover, in some embodiments, the act of obtaining or providing the heat exchanger may include, obtaining or providing a heat exchanger that may have, for example, multiple parallel tubes that are multi-tubes, that each have multiple parallel fluid passageways therethrough, for example. In a number of specific embodiments, for example, the multi-tubes may each have multiple contiguous fluid passageways, for instance, arranged in at least one row, and in many embodiments there may be fins mounted between the multiple parallel tubes.

In various embodiments, a heat exchanger may have, for example, a fin angle that is at least 20 degrees. Further, in some embodiments, the act of mounting the heat exchanger may include positioning the heat exchanger so that the first angle is at least 15 degrees less than the second angle. Even further, in some embodiments, the act of mounting the heat exchanger may include positioning the heat exchanger so that the fin angle plus the first angle may be substantially equal to the second angle, as another example. Further still, in some embodiments, the act of mounting the heat exchanger includes positioning the heat exchanger so that a fourth angle between a predominant air-flow direction after leaving the heat exchanger and the fins is less than a fifth angle between the predominant air-flow direction after leaving the heat exchanger and the perpendicular direction, as yet another example.

In addition, various other embodiments of the invention are also described herein, and other benefits of a number of embodiments may be apparent to a person of ordinary skill in the art.

### DETAILED DESCRIPTION OF EXAMPLES OF EMBODIMENTS

Various embodiments include heating, ventilating, and air conditioning (HVAC) units and systems, heat exchangers, buildings having such equipment, and methods of manufacturing HVAC units, systems, and heat exchangers, for example. As used herein “HVAC units” include air conditioning units (e.g., direct expansion units), heat pumps, split systems, packaged units, air handlers (e.g., indoor units for split systems), and condensing units (e.g., outdoor units for split systems), as examples.

A number of embodiments include improvements over prior technology that promote draining of condensation from heat exchangers, such as evaporators, that reduce air-flow restriction through the heat exchanger, or both, as examples. Particular embodiments involve slopping fins, louvers, or both, for example, downward in the direction of air flow or upward in the direction of air flow. In some embodiments, micro-channels or multi-tubes are also sloped or are oriented at or near vertical, which may be used, for instance, to provide a pathway for condensation thereon, to allow the fins to be angled to reduce air-flow restriction, or both, as examples.

Different embodiments utilize slanted fin profiles (e.g., between adjacent micro-channels) to facilitate the drainage of condensate, to improve air flow, or both. This may cause the air flow to traverse the coil at an angle (e.g., as opposed to being perpendicular to the heat exchanger). In some embodiments, the slanted or angled construction or orientation of the fins causes or encourages the condensate to flow downhill at each fin-to-micro-channel interface and onto the nose of the micro-channel or multi-tube, for example, where the condensation may flow downward unimpeded, for instance. Coils or heat exchangers built in this fashion may perform satisfactorily as evaporators and as heat pump condensers, for example.

In other embodiments, removal of condensation may not be as important as reducing air-flow restriction, and fins may be angled so that air flows upward through the heat exchanger (e.g., past the fins) to reduce air-flow restriction in situations where upward air flow is desirable. In particular embodiments, effective condensation removal and reduction in air-flow restriction may both be accomplished.

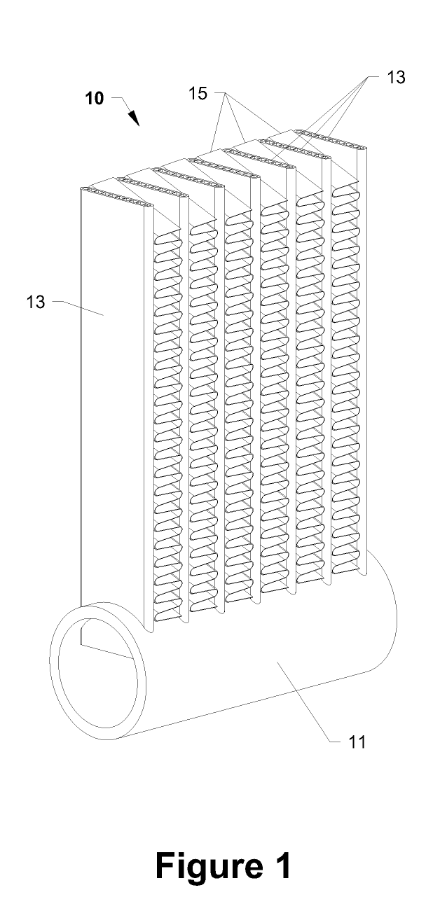

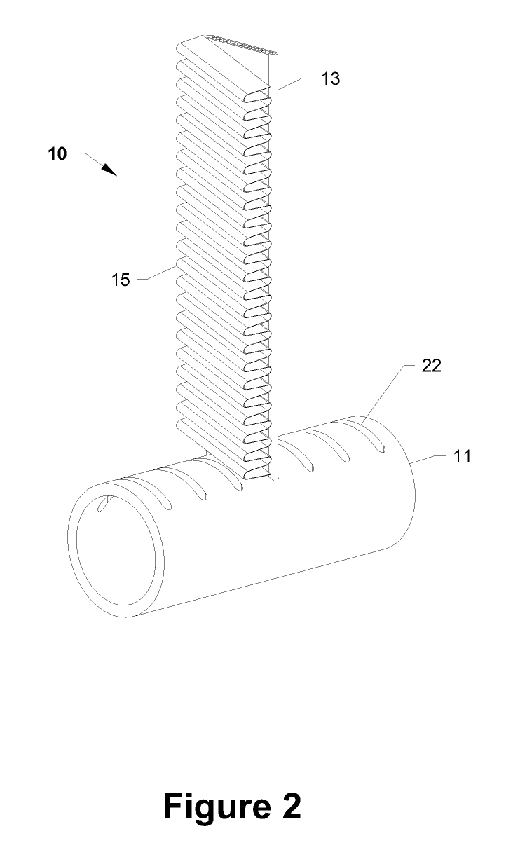

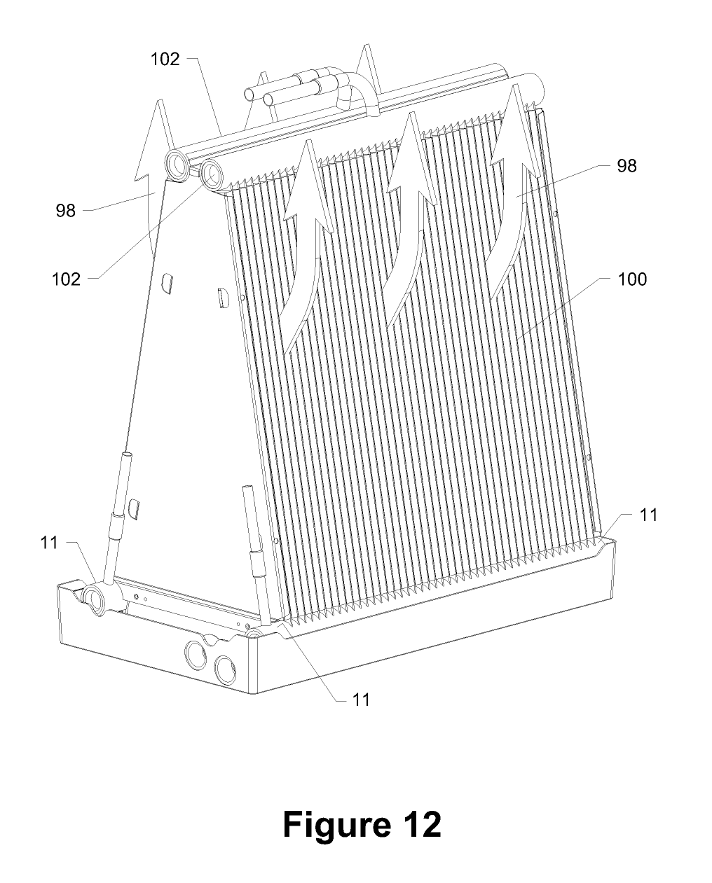

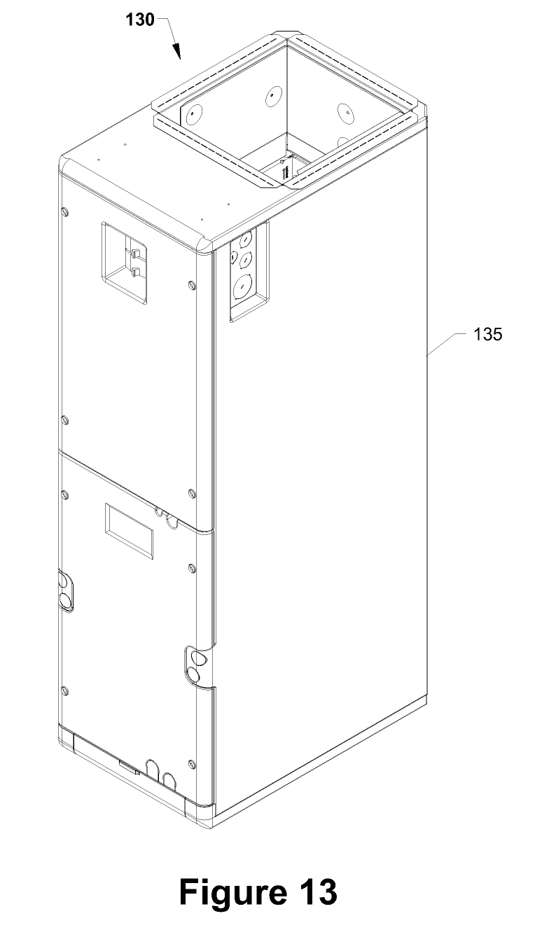

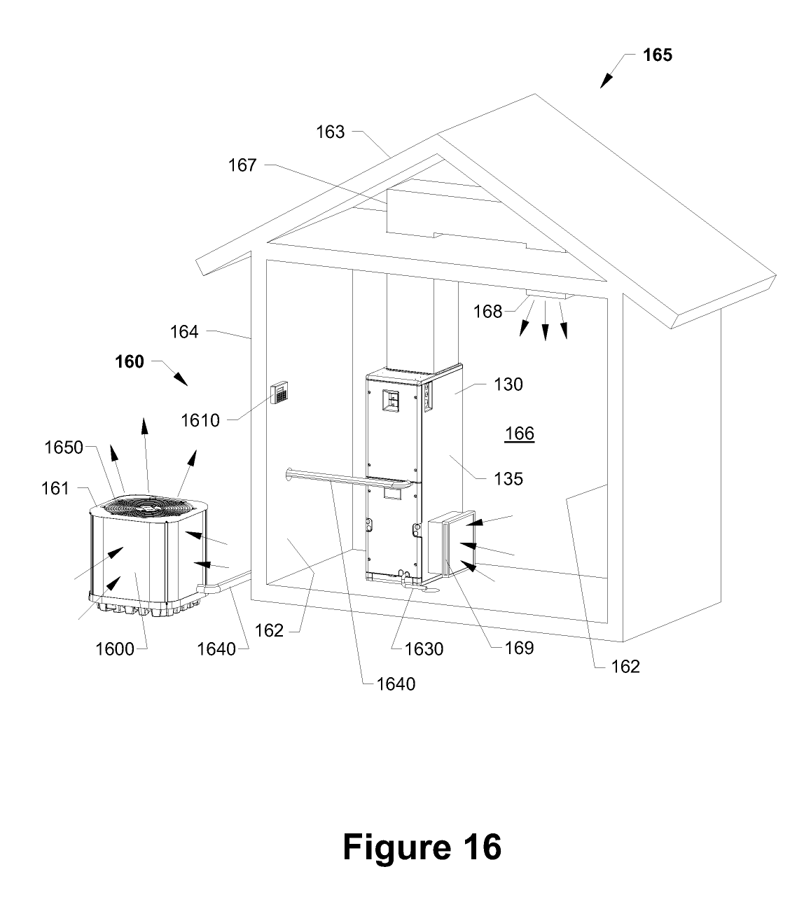

FIG. 1 to FIG. 12 and FIG. 14 to FIG. 15 illustrate examples of (all or part of some) heat exchangers, and FIGS. 13 to FIG. 15 illustrate an example of an HVAC unit having at least one (e.g., such) heat exchanger. In addition, FIG. 16 illustrates a building having an HVAC unit (e.g., the unit of FIG. 13 to FIG. 15 plus an outdoor portion) and an HVAC system. In FIG. 1 to FIG. 3, first header tube 11 is attached to multi-tubes 13 that fit into slots 22 (shown in FIG. 2) in first header tube 11. Slanted fins 15, in this embodiment, are located between multi-tubes 13. As used herein, “slanted” means not horizontal and not vertical. Specifically, “slanted” means more than five (5) degrees from horizontal and more than five (5) degrees from vertical. When referring to micro-channel heat exchangers, for example, whether or not a fin (e.g., 15) is slanted is measured along the centerline of the fin midway between adjacent micro-channels (e.g., multi-tubes 13). In the embodiment illustrated, first header tube 11, multi-tubes 13, and fins 15 form part of (e.g., a portion of) heat exchanger 10. A complete heat exchanger 10 would also have a top or second header tube, multi-tubes 13 would be longer (e.g., taller), and there would be more multi-tubes 13 and more columns of fins 15. In this embodiment, fins 15 of heat exchanger 10 lack enhancements such as louvers. In many embodiments, fins 15 are bonded to multi-tubes 13, for example, via brazing.

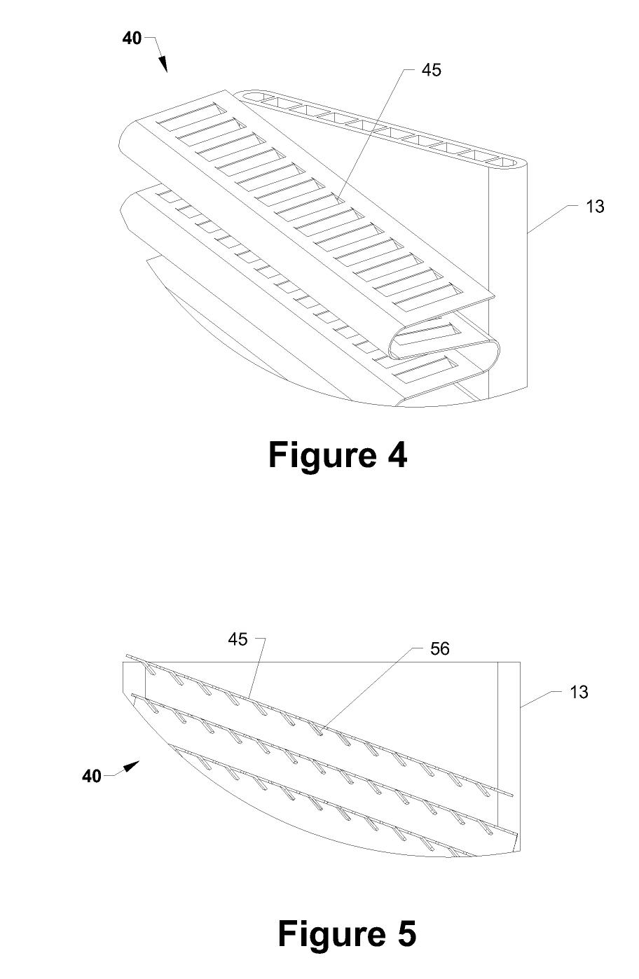

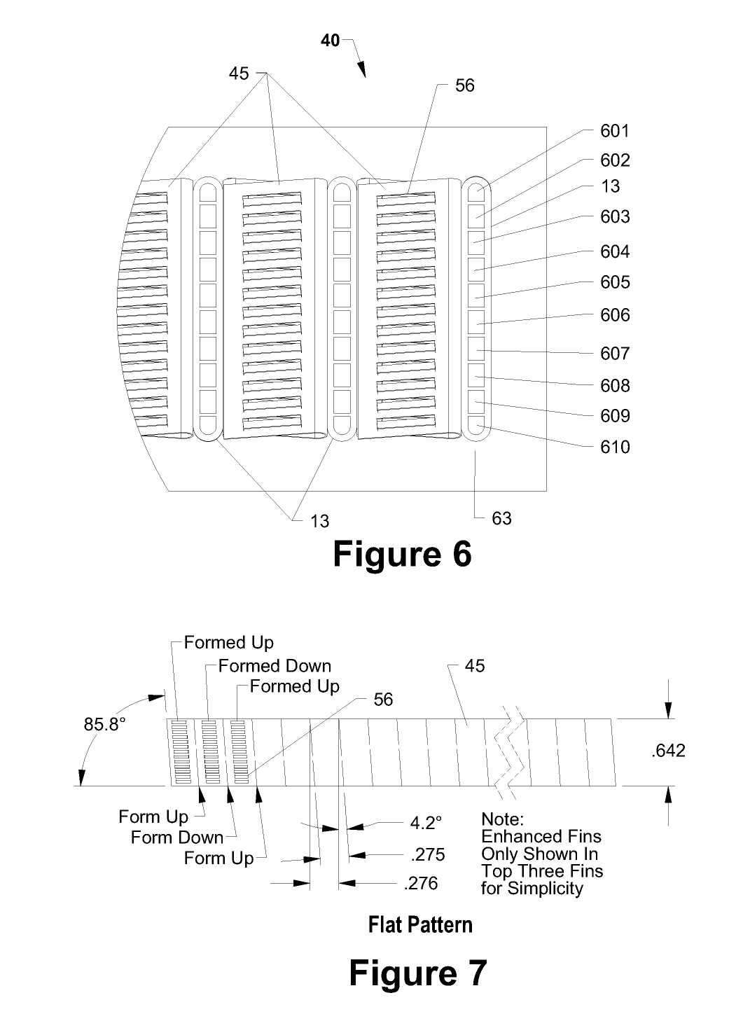

FIG. 4 to FIG. 6 illustrate another embodiment of a heat exchanger, heat exchanger 40, that has louvers 56 formed in fins 45 to enhance heat transfer between heat exchanger 40 and air passing by fins 45. Heat exchangers 10 and 40 may be similar other than louvers 56. As seen in FIG. 6, multi-tubes 13 comprise multiple (e.g., 10) contiguous passageways 601 to 610, for example, for refrigerant. In the embodiment illustrated, the multiple contiguous passageways 601 to 610 of each multi-tube 13 are arranged in a row 63 (e.g., one row 63 per multi-tube 13).

Further, FIG. 7 shows a flat pattern for fins 45 of heat exchanger 40, as an example of a slant fin flat pattern. (A flat pattern for fins 15 of heat exchanger 10 may be similar, except lacking louvers 56.) Flat sheet metal may be cut and bent as shown to form the fins (e.g., 45), for example. Louvers 56 may be cut in rows at an angle and bent up or down as shown. Then the metal may be bent back and forth between the louvers to form the slanted or angled fins (e.g., 15, 45, or 85) at the desired angle. In FIG. 7, louvers 56 are only shown for the three fins on the left, but in many embodiments, louvers 56 would be formed on each fin (e.g., of fins 45). In FIG. 7, the linear dimensions shown are in inches. The dimensions, angles, and enhancements shown are examples. Other embodiments may differ.

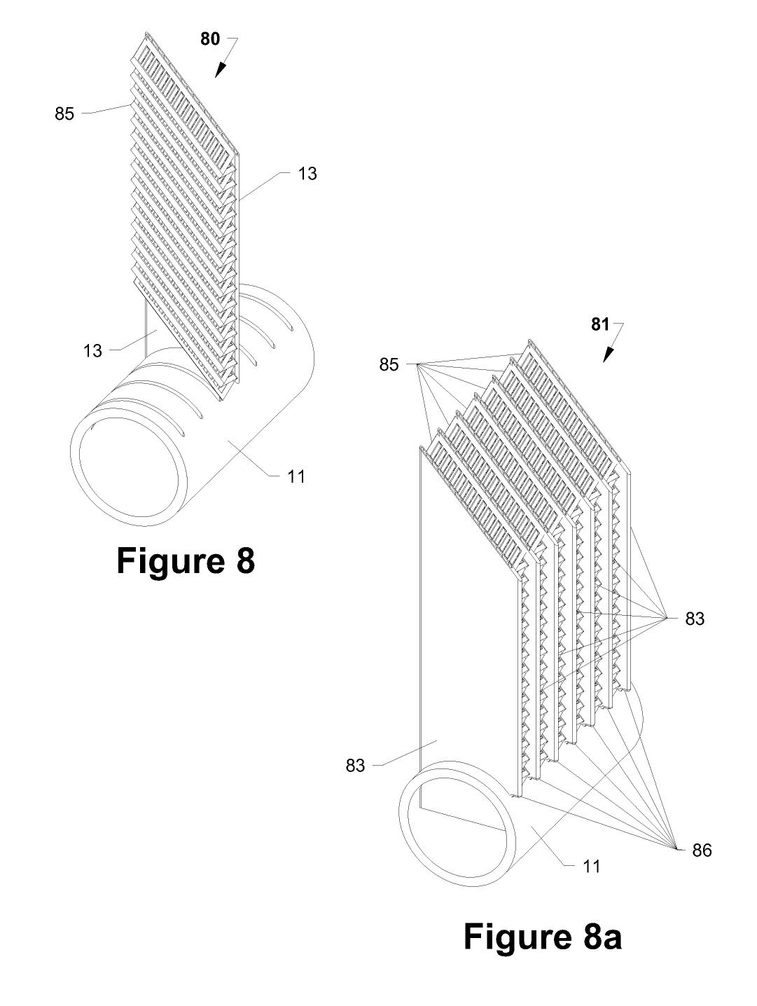

FIG. 8 shows part of another example of a heat exchanger with slanted fins, heat exchanger 80, which has fins 85. Heat exchanger 80 also includes first header tube 11 and multi-tubes 13 (only one shown), similar to previously described embodiments. Heat exchanger 80 has fins 85 set at a steeper angle, however, than fins 15 and 45 of the previously described embodiments. As illustrated, fins 85 also have enhancements, which may be louvers similar to louvers 56, for example.

FIG. 8a shows part of another example of a heat exchanger with slanted fins, heat exchanger 81, which also has fins 85 similar to heat exchanger 80. Heat exchanger 81 also includes first header tube 11, similar to previously described embodiments, but has multi-tubes 83 (seven shown) that extend beyond fins 85 on the right side of heat exchanger 81, for example, to promote runoff of condensation down nose or projecting edge 86 of multi-tubes 83. Multi-tubes 83 may be similar to multi-tubes 13 except for this different dimension, the number of contiguous passageways (e.g., 601 to 610 shown in FIG. 6) therein, or both, for example. Heat exchanger 81 also has fins 85 set at a steeper angle, for example, than fins 15 and 45 of some of the previously described embodiments.

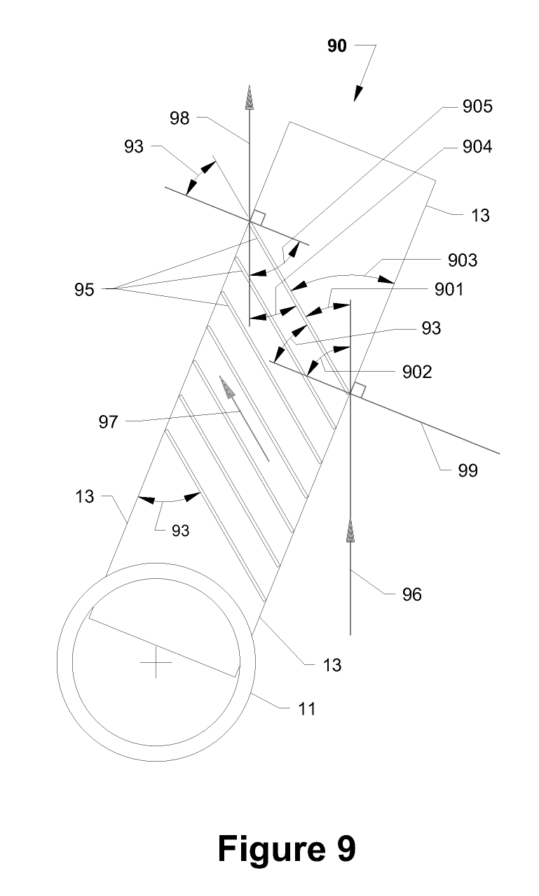

FIG. 9 illustrates, among other things, various directions and angles that may be found in different embodiments of heat exchangers and equipment (e.g., HVAC units) that include heat exchangers. Heat exchanger 90 may be, for example, heat exchanger 10, heat exchanger 40, heat exchanger 80, heat exchanger 81, or a different embodiment heat exchanger, for instance. In the embodiment illustrated, air approaches heat exchanger 90 at a predominant air-flow direction 96. Fins 95 (e.g., fins 15, 45, or 85) turn the air so that the air flows parallel to the fins at predominant air-flow direction 97 within heat exchanger 90. In some embodiments, when the air leaves heat exchanger 90 and leaves fins 95, the air changes direction to the predominant air-flow direction 98 leaving heat exchanger 90. In a number of embodiments, such changes in direction may not be abrupt, but may occur (e.g., for a particular molecule of air) over a certain time or distance, for instance.

Certain angles shown in FIG. 9 include fin angle 93 between fin 95 and perpendicular direction 99. Perpendicular direction 99 may be perpendicular to heat exchanger 90, perpendicular to first header tube 11, perpendicular to multi-tubes 13, perpendicular to the passageways (e.g., 601 to 610 shown in FIG. 6) within multi-tubes 13, or a combination thereof, as examples. Further, first angle 901 is between the predominant air-flow direction 96 approaching heat exchanger 90 and fins 95, and second angle 902 is between the predominant air-flow direction 96 approaching heat exchanger 90 and perpendicular direction 99. Moreover, third angle 903 is between fins 95 and adjacent multi-tube 13, fourth angle 904 is between the predominant air-flow direction 98 leaving heat exchanger 90 and fins 95, and fifth angle 905 is between the predominant air-flow direction 98 leaving heat exchanger 90 and perpendicular direction 99.

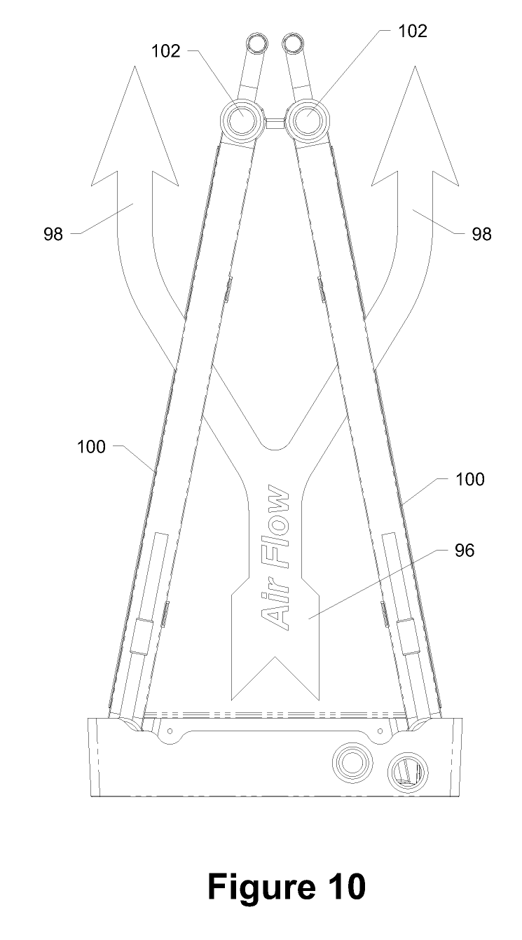

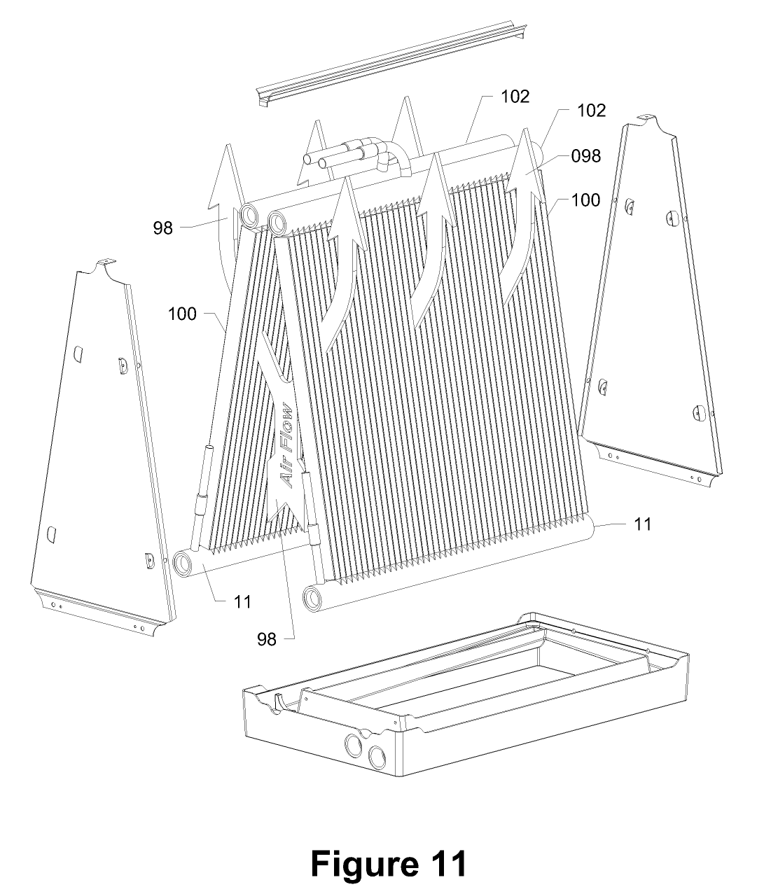

FIG. 10 to FIG. 15 illustrate how two heat exchangers 100 may be arranged in an HVAC unit 130, for example. Heat exchangers 100 may be heat exchanger 10, 40, 80, 81, or 90, as examples, or may be a different embodiment. FIG. 10 to FIG. 12 and FIG. 14 also illustrate that heat exchangers (e.g., 100) may include a second header tube 102 located at the top of the heat exchanger, which may be attached to multi-tubes (e.g., 13 or 83) similarly to first header tube 11, for instance. FIG. 10 to FIG. 12 and FIG. 14 also illustrate the air-flow direction through heat exchangers 100 from a predominant air-flow direction 96 approaching the heat exchangers 100 to a predominant air-flow direction 98 leaving the heat exchangers 100, in this embodiment.

A number of embodiments include at least one HVAC unit (e.g., 130 shown in FIG. 13 to FIG. 15)) having at least one heat exchanger (e.g., 90 or 100) that has a predominant air-flow direction (e.g., 97 shown in FIG. 9). The predominant air-flow direction (e.g., 97) may be from one side of the heat exchanger to the other, for example, through the heat exchanger (e.g., from the right side to the left side as shown in FIG. 9). In various embodiments, the heat exchanger (e.g., 90 or 100) may include a first refrigerant header or header tube (e.g., 11) and a second refrigerant header or header tube (e.g., 102 shown in FIG. 10 to FIG. 12 and FIG. 14), and multiple parallel multi-tubes (e.g., 13 or 83) extending from the first refrigerant header or header tube (e.g., 11) to the second refrigerant header or header tube (e.g., 102), for example.

Headers and header tubes described herein (e.g., 11 and 102) may have a round, square, rectangular, or other cross section, for example, which may be a continuous cross-section, or may be a cross section that varies in size, shape, or both, over the length of the header tube, as examples. Round cross-section header tubes are shown (e.g., in FIG. 1 to FIG. 3 and FIG. 8 to FIG. 12), with a continuous size and shape cross-section, with slots (e.g., 22 shown in FIG. 2) formed therein to receive the multi-tubes (e.g., 13 or 83). In some embodiments, the multi-tubes (e.g., 13 or 83) may be parallel to each other geometrically (e.g., as shown in FIG. 1, FIG. 6, and FIG. 8a), arranged in parallel with respect to flow of the refrigerant (e.g., as shown in the embodiments illustrated), or both, for example.

As used herein, “parallel”, when referring to a geometric arrangement, means parallel to within two degrees, and “substantially parallel”, means parallel to within five degrees. Further, as used herein, “arranged in parallel with respect to flow of the refrigerant” means that the flow of refrigerant is divided between the passageways that are said to be arranged in parallel with respect to flow of the refrigerant, for example, multi-tubes. In some embodiments, the predominant air-flow direction (e.g., 97 shown in FIG. 9) may be perpendicular to the first refrigerant header tube (e.g., 13 or 83), perpendicular to the second refrigerant header tube (e.g., 102 shown in FIG. 10 to FIG. 12 and FIG. 14), or both, for example.

In various embodiments, each multi-tube (e.g., 13 shown in detail in FIG. 6) may have multiple contiguous parallel refrigerant passageways (e.g., 601 to 610) therethrough, which may be arranged in at least one row (e.g., row 63 as shown in FIG. 6) in some embodiments, for example. Rows (e.g., 63) described herein may be straight (e.g., as shown in FIG. 6) or may be curved in some embodiments, as examples. The multiple contiguous parallel refrigerant passageways (e.g., 601 to 610) may be parallel (e.g., geometrically, with respect to the flow of refrigerant, or both) to each other, for instance, and parallel to the multi-tube (e.g., 13 or 83), for example. In some cases, multi-tubes (e.g., 13 or 83) may be referred to as micro-channels. As used herein, rows (e.g., 63) of contiguous refrigerant passageways (e.g., 601 to 610) are perpendicular to the multi-tubes (e.g., 13) or micro-channels, as shown.

As the name “micro-channel” implies, each of the contiguous refrigerant passageways (e.g., 601 to 610) may be fairly small, for example, in comparison to single-channel tubing in other heat exchanger configurations, for instance. The reduced size and increased number of refrigerant passageways (e.g., 601 to 610) may enhance heat transfer between the refrigerant and the material or walls of the heat exchanger (e.g., of multi-tubes 13), for example, by providing more surface area than alternatives, by providing turbulence, or both, as examples.

As shown in the drawings, in a number of embodiments, each heat exchanger module includes multiple fins (e.g., 15, 45, 85, or 95) between the multi-tubes (e.g., 13 or 83), which may help to transfer heat between the multi-tubes (e.g., 13 or 83) and the air, for example. In a number of embodiments, the fins (e.g., 15, 45, 85, or 95) are bonded to the multi-tubes (e.g., 13 or 83), for example, to promote heat transfer between the fins (e.g., 15, 45, 85, or 95) and the multi-tubes (e.g., 13 or 83), to provide for structural strength of the heat exchanger, or both, as examples. Bonding of the fins (e.g., 15, 45, 85, or 95) to the multi-tubes (e.g., 13 or 83) may be accomplished with solder or brazing, as examples.

In various embodiments, the multi-tubes (e.g., 13 or 83) are oriented non-horizontally in the HVAC unit, at an angle that is closer to vertical than to horizontal (e.g., as shown in FIG. 9 and FIG. 10 to FIG. 12), substantially vertically, or even vertically (e.g., as shown in FIG. 1 to FIG. 6, FIG. 8, and FIG. 8a), as examples. Such an orientation of the multi-tubes (e.g., 13 or 83) may help to drain condensation from the heat exchanger, in some embodiments, by acting as a pathway for condensation to travel along (e.g., down) while adhering to the exterior of the multi-tube (e.g., 13 or 83) through surface tension, for example. As used herein, “non-horizontal means at least 7 degrees from horizontal. Further, as used herein, “substantially vertically” means vertical to within 5 degrees, and “vertically” means vertical to within 2 degrees. In addition, as used herein, words that indicate direction, such as vertical, horizontal, above, below, up, down, downward, upward, and the like, refer to the orientation in which the HVAC unit (e.g., 130 shown in FIG. 13 to FIG. 16 or 161 shown in FIG. 16), air conditioning unit, heat exchanger (e.g., 10, 40, 80, 81, 90, 100, or 1600), or the like, is normally installed.

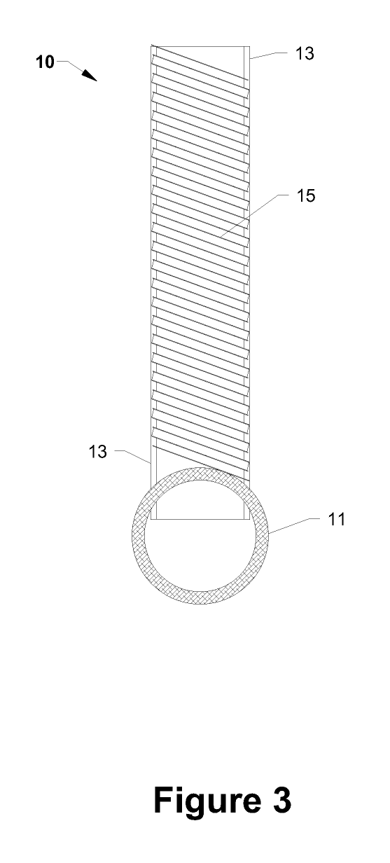

In some embodiments, the fins (e.g., 15, 45, 85, or 95), mentioned above, are slanted downward, for example, in the air-flow direction. In various embodiments, the air-flow direction may be the predominant air-flow direction (e.g., 97 shown in FIG. 9) of the heat exchanger (e.g., 90), or of part of the heat exchanger, for example, or the air-flow direction may be perpendicular to the refrigerant flow direction in the multi-tubes (i.e., perpendicular to the multi-tubes 13 or 83), perpendicular to the refrigerant flow direction in the headers (e.g., 11 and 102), parallel to the rows (e.g., 63), parallel to the fins (e.g., 15, 45, 85, or 95), or a combination thereof, as examples. In FIG. 3, for instance, in embodiments in which the fins 15 slope downward in the air-flow direction, the (e.g., predominant) air-flow direction is from left to right, or from left to right at a downward angle parallel to fins 15, in various embodiments.

In some embodiments, the fins (e.g., 15, 45, 85, or 95) are slanted (e.g., downward in the air-flow direction) at an angle from horizontal that is greater than 5 degrees, greater than 7 degrees, greater than 10 degrees, between 5 degrees and 60 degrees, between 7 degrees and 45 degrees, between 10 degrees and 30 degrees, between 15 degrees and 25 degrees, between 17.5 degrees and 22.5 degrees, or 20 degrees (e.g., as shown in FIG. 1 to FIG. 7), as examples. The angle of the fins (e.g., 15, 45, 85, or 95) from horizontal (e.g., fin angle 93 shown in FIG. 9 in embodiments where the multi-tubes 13 are oriented vertically) used may be determined empirically, for example, and may be selected, in some embodiments, to promote the drainage of condensate from the coil (e.g., from fins 15 or 45 shown in FIG. 1 to FIG. 7), while avoiding excessive air-flow restriction, for instance.

In some embodiments, the angled fin profiles may be formed by feeding strip stock into a forming mechanism at a desired angle or by using helical gears, as another example, or by other forming mechanisms. Fins (e.g., 15, 45, 85, or 95) may be formed by bending or folding sheet metal back and forth, for instance (e.g., as shown in FIG. 1, FIG. 2, FIG. 4, and FIG. 7). In some embodiments that have louvers or lances (e.g., louvers 56 shown in FIG. 4 to FIG. 7), the louvers or lances may be arrayed at the same angle in the strip stock from which the fins (e.g., 45 or 85) are being formed, for instance. The drawings illustrate certain examples. Specifically, FIG. 1 to FIG. 3 and FIG. 9 show a plain fin and FIG. 4 to FIG. 8a show a louvered or lanced (e.g., with louvers 56) fin type.

In some embodiments, some, multiple or all of the fins (e.g., 45 and 85) include multiple enhancements, such as lances or louvers 56, for example, as shown in FIG. 4 to FIG. 8a. In particular embodiments, the louvers are slanted (e.g., downward in the air-flow direction), for instance, more steeply than the fins (e.g., 45 shown in FIG. 4). In the embodiment illustrated in FIG. 4, each fin 45 has 13 louvers, each defined by a bend and three cuts, one long cut and two shorter cuts. In the embodiment illustrated, the bend is about 45 degrees. Other embodiments may have 2, 3, 4, 5, 6, 7, 8, 9, 10, 11, 12, 14, 15, 16, 17, 18, 19, 20, or 25 louvers per fin, and may have bends of 20, 30, 35, 40, 50, 55, 60, or 70 degrees, as examples. Other embodiments may have other shape or type louvers or enhancements, many of which may be known in the art of heat exchanger design.

Certain embodiments of air conditioning or HVAC units have just one micro-channel heat exchanger (e.g., 10, 40, 80, 81, or 90), while other embodiments may have (at least) two micro-channel heat exchangers, for instance, used as the evaporator and the condenser. Specifically, in some embodiments, an HVAC unit includes at least two heat exchangers, each heat exchanger having a first refrigerant header tube (e.g., 11 shown in FIG. 1 to FIG. 3) and a second refrigerant header tube (e.g., 102 shown in FIG. 10 to FIG. 12) and multiple parallel multi-tubes (e.g., 13 or 83) extending from the first refrigerant header tube (e.g., 11) to the second refrigerant header tube (e.g., 102). In many such embodiments, the multi-tubes (e.g., 13 or 83) may be parallel to each other geometrically, arranged in parallel with respect to the flow of the refrigerant, or both, for example.

In some such embodiments, each multi-tube (e.g., 13 or 83) may have multiple contiguous parallel refrigerant passageways (e.g., 601 to 610 shown in FIG. 6) therethrough arranged, for example, in at least one row (e.g., 63). In FIG. 6, for example, each multi-tube 13 has ten (10) contiguous parallel refrigerant passageways 601 to 610 therethrough arranged in one row 63. In other embodiments, multi-tubes (e.g., otherwise similar to multi-tube 13) may have 3, 4, 5, 6, 7, 8, 9, 11, 12, 13, 14, 15, 16, 18, 20, 22, 25, 30, 35, or 40 contiguous parallel refrigerant passageways therethrough, for example, arranged, for instance, in 1, 2, 3, 4, or 5 rows, for instance.

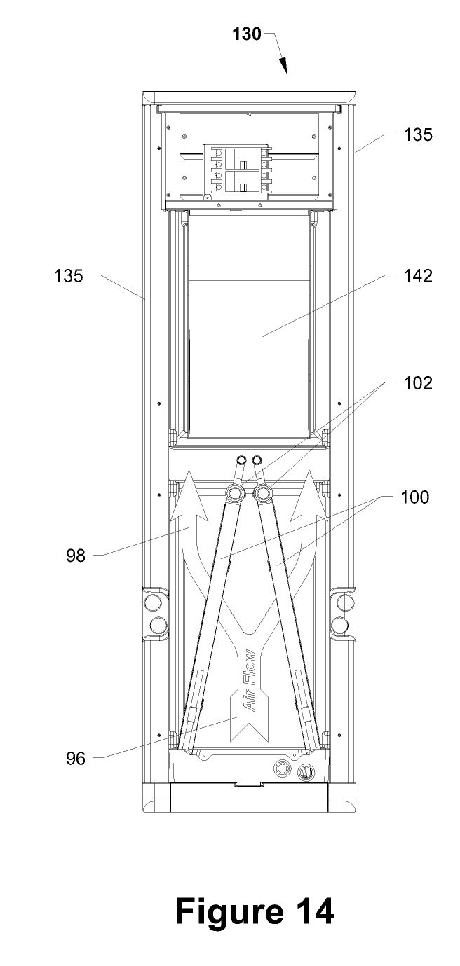

In some embodiments, the HVAC unit (e.g., 130, or 130 plus outdoor unit 161 shown in FIG. 16) includes at least two heat exchangers (e.g., at least one heat exchanger 100 shown in FIG. 14 plus at least one heat exchanger 1600 shown in FIG. 16), each of which may be a micro-channel heat exchanger, for example, and may have fins (e.g., 15, 45, 85, or 95), multi-tubes (e.g., 13 or 83), and a predominant air-flow direction (e.g., 97), for instance. In some embodiments, in both heat exchangers (e.g., 100 and 1600), the multi-tubes (e.g., 13 or 83) are oriented non-horizontally in the HVAC unit (e.g., unit 130, unit 161, or both), the fins (e.g., 15, 45, 85, or 95) are slanted (e.g., downward in the air-flow direction), or both, as examples. In particular such embodiments, the HVAC unit (e.g., 130, 161, or both) is a heat pump, for example, and in both the evaporator (e.g., 100) and condenser (e.g., 1600) (e.g., the later used as an evaporator in the heating mode), the multi-tubes (e.g., 13 or 83) are oriented non-horizontally, the fins (e.g., 15, 45, 85, or 95) are slanted (e.g., downward in the air-flow direction), or both, as examples.

Another example of an embodiment is specifically a heat exchanger (e.g., 10, 40, 80, 81, 90, 100, or 1600), for instance, for transferring heat from air to a working fluid. Such a working fluid may be a refrigerant, such as Freon, for example, or may be another heat-conducting fluid such as water, ethylene glycol, or a combination of water and ethylene glycol, as examples. Different embodiments of such a heat exchanger (e.g., 10, 40, 80, 81, 90, 100, or 1600) may be used in environments where the air may contain moisture (e.g., of a sufficient humidity that condensation would occur at a working temperature of the heat exchanger).

In various embodiments, such a heat exchanger (e.g., 10, 40, 80, 81, 90, 100, or 1600) may include a first working fluid header tube (e.g., 11 shown in FIG. 1 to FIG. 3, FIG. 8, FIG. 8a, and FIG. 11), a second working fluid header tube (e.g., 102 shown in FIG. 10 to FIG. 12 and FIG. 14), and multiple parallel multi-tubes (e.g., 13 or 83) extending from the first working fluid header tube (e.g., 11) to the second working fluid header tube (e.g., 102), for example. In certain embodiments, the multi-tubes (e.g., 13 or 83) may be parallel to each other geometrically, arranged in parallel with respect to flow of the working fluid, or both, for example. In particular embodiments, each multi-tube (e.g., 13 or 83) may have multiple contiguous parallel working fluid passageways therethrough (e.g., 601 to 610 shown in FIG. 6) arranged, for instance, in at least one row (e.g., 63). In some embodiments, there are multiple fins (e.g., 15, 45, 85, or 95) between the multi-tubes (e.g., 13 or 83), which may be bonded to the multi-tubes (e.g., 13 or 83), for instance.

In some embodiments, the fins (e.g., 15, 45, 85, or 95) of the heat exchanger (e.g., 10, 40, 80, 81, 90, 100, or 1600) are oriented at an angle that is less than 80 degrees, that is less than 75 degrees, that is between 45 and 80 degrees, between 60 and 80 degrees, between 65 and 75 degrees, between 67.5 and 72.5 degrees or at an angle of 70 degrees (e.g., as shown in FIG. 1 to FIG. 3) from the multi-tubes (e.g., 13), for example. As used herein, such an angle is measured from the centerline of the flow passageways (e.g., 601 to 610) in the direction of the working fluid or refrigerant flow, for example. In some embodiments of a heat exchanger (e.g., 10, 40, 80, 81, 90, 100, or 1600), the first working fluid header tube (e.g., 11) is substantially parallel to, or parallel to, the second working fluid header tube (e.g., 102), as examples. Further, in a number of embodiments, the multi-tubes (e.g., 13 or 83) are substantially perpendicular to, or perpendicular to, the first working fluid header tube (e.g., 11), for example. As used herein, “perpendicular” means perpendicular to within 2 degrees, and “substantially perpendicular” means perpendicular to within 5 degrees. In the embodiments shown, the rows (e.g., 63 as shown in FIG. 6) are perpendicular to the multi-tubes (e.g., 13) and the rows (e.g., 63) are perpendicular to the first working fluid header tube (e.g., 11), for example.

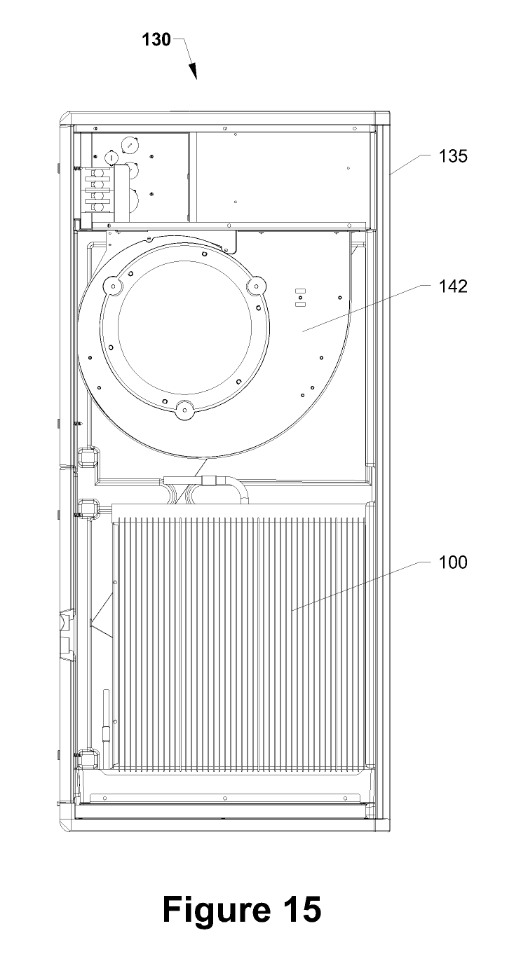

Other embodiments include a building (e.g., 165 shown in FIG. 16) that includes an HVAC unit (e.g., indoor unit or air handler 130, outdoor unit or condenser 160, or both), an HVAC system (e.g., 160), an air conditioning unit (e.g., evaporator, indoor unit, or air handler 130, outdoor unit or condenser 160, or both), a heat exchanger (e.g., 10, 40, 80, 81, 90, 100, or 1600) described herein, or a combination thereof, as examples. Or various embodiments of buildings (e.g., 165) may include an HVAC unit, HVAC system, or air conditioning unit, having a heat exchanger (e.g., 10, 40, 80, 81, 90, 100, or 1600) described herein, as examples. Such a building (e.g., 165) may include walls 162 and roof 163, and may form an enclosure 164 or enclose an (e.g., occupied) space 166, for example. Building 165 or HVAC system 160 may include, besides an HVAC unit (e.g., indoor unit or air handler 130, outdoor unit or condenser 160, or both), supply and return air ductwork (e.g., supply ductwork 167 shown), registers (e.g., 168), an air filter (e.g., 169), a thermostat or controller (e.g., 1610), a condensation drain (e.g., 1630), or a combination thereof, for example. HVAC units (e.g., indoor unit or air handler 130, outdoor unit or condenser 160, or both) may include a compressor, evaporator and condenser fans (e.g., evaporator fan 142 shown in FIG. 14 and FIG. 15 and evaporator fan 1650 shown in FIG. 16), motors for the compressor and fans, a housing (e.g., 135 shown in FIG. 13 to FIG. 16), wiring, controls (e.g., thermostat or controller 1610), refrigerant tubing (e.g., 1640 shown in FIG. 16), an expansion valve, and the like. In different embodiments, HVAC units may be packaged units or may be spit systems (e.g., indoor unit or air handler 130, outdoor unit or condenser 160, or both), as examples.

Various embodiments include HVAC units that have a heat exchanger (e.g., 10, 40, 80, 81, 90, 100, or 1600) that has angled or slanted fins (e.g., 15, 45, 85, or 95), for instance, as described herein. As an example, FIG. 13 to FIG. 16, illustrate an example of an HVAC unit or air handler 130 that includes a heat exchanger (e.g., 100) having slanted fins (e.g., 15, 45, 85, or 95 shown in FIG. 1 to FIG. 8a) that may be used to reduce air-flow restriction, which may thereby improve air flow, for example. The heat exchanger fins (e.g., 15, 45, 85, or 95) of a number of embodiments may be angled or slanted as shown, for example, or as described in various embodiments herein.

In some embodiments, the HVAC unit (e.g., 130) may have a predominant air-flow direction (e.g., 96 shown in FIG. 9) approaching the heat exchanger (e.g., 90), and the heat exchanger (e.g., 90) may have a perpendicular direction (e.g., 99) that may be perpendicular, for instance, to the first header tube (e.g., 11), to the second header tube (e.g., 102), to the multi-tubes (e.g., 13 or 83), or a combination thereof, as examples. Further, in FIG. 10 and FIG. 14, and end view shows two heat exchangers 100 and a thick arrow with portion 96 that represents the predominant air-flow direction approaching heat exchangers 100. In this illustration, the predominant air-flow direction 96 approaching the heat exchanger (e.g., 100) is vertically up. In FIG. 9, the predominant air-flow direction 96 approaching the heat exchanger (e.g., 90) is also vertically up. In other embodiments, however, the predominant air-flow direction approaching the heat exchanger may be in another direction such as vertically down, angled downward, horizontal, or angled upward, as other examples.

Referring to FIG. 9, in some embodiments, including the embodiment illustrated, first angle 901 between predominant air-flow direction 96 approaching the heat exchanger 90 and the fins 95, is less than second angle 902 between the predominant air-flow direction 96 approaching the heat exchanger 90 and perpendicular direction 99. In some embodiments, the difference between first angle 901 and second angle 902 provides benefit at reducing air-flow restriction or improving air flow, for instance, because it is not necessary to change the direction of air flow as much as if, as in the prior art, the fins were parallel to perpendicular direction 99.

In some embodiments, a heat exchanger (e.g., 10, 40, 80, 81, 90, 100, or 1600), which may be for transferring heat between air and a working fluid (e.g., a refrigerant), may have, for example, a first working fluid header tube (e.g., 11), a second working fluid header tube (e.g., 102), and multiple parallel tubes (e.g., multi-tubes (e.g., 13 or 83)) extending, for instance, from the first working fluid header tube (e.g., 11) to the second working fluid header tube (e.g., 102). In some embodiments, the parallel tubes (e.g., the multi-tubes 13 or 83) may be parallel to each other geometrically, arranged in parallel with respect to flow of the working fluid, or both. And in certain embodiments, each parallel tube or multi-tube (e.g., 13 or 83) may have multiple contiguous parallel working fluid passageways (e.g., 601 to 610 shown in FIG. 6) therethrough, which may be arranged in at least one row (e.g., 63), for instance.

In a number of embodiments, there may be multiple fins (e.g., 15, 45, 85, or 95) between the parallel tube or multi-tubes (e.g., 13 or 83), and the fins (e.g., 15, 45, 85, or 95) may be bonded to the parallel tubes or multi-tubes. In particular embodiments, the fins (e.g., 15, 45, 85, or 95) may be oriented at an angle (e.g., third angle 903 shown in FIG. 9), which may be between 30 and 80 degrees from the parallel tubes or multi-tubes (e.g., 13 or 83), or between 45 and 80 degrees from the parallel tubes or multi-tubes for instance. Other ranges for third angle 903 include: between 20 and 80 degrees, between 30 and 70 degrees, between 10 and 60 degrees, between 30 and 60 degrees, between 40 and 55 degrees, between 45 and 50 degrees, and between 40 and 50 degrees. Other ranges for third angle 903, which may correspond to other embodiments, may be described herein.

Still referring to FIG. 9, in various embodiments, first angle 901 is at least 5 degrees less than second angle 902, at least 10 degrees less than second angle 902, or at least 15 degrees less than second angle 902, as examples. Further, in certain embodiments, first angle 901 is at least 20 degrees less than second angle 902, at least 25 degrees less than second angle 902, at least 30 degrees less than second angle 902, at least 35 degrees less than second angle 902, at least 40 degrees less than second angle 902, or at least 45 degrees less than second angle 902, as other examples.

Further, in some embodiments first angle 901 is about 47.5 degrees less than second angle 902, or is 47.5 degrees less than second angle 902, as examples. As used herein, the word “about”, when referring to angles, means plus or minus ten percent of the angle. Further, as used herein, without the word “about”, (or another modifier), unless stated otherwise, the tolerance on angles to the nearest whole degree. For example, 47.5 degrees, without a modifier and unless stated otherwise, means more than 47 degrees and less than 48 degrees. Further, in some embodiments, first angle 901 is no more than 45 degrees less than second angle 902, first angle 901 is no more than 50 degrees less than second angle 902, first angle 901 is no more than 55 degrees less than second angle 902, first angle 901 is no more than 60 degrees less than second angle 902, first angle 901 is no more than 65 degrees less than second angle 902, or first angle 901 is no more than 70 degrees less than second angle 902, as further examples.

In a number of embodiments, the fins (e.g., 95 shown in FIG. 9) are oriented at a third angle 903 from the multi-tubes (e.g., 13 or 83), and third angle 903 plus second angle 902 minus first angle 901, is substantially equal to 90 degrees. As used herein, “substantially equal”, when referring to an angle, means equal to within 5 degrees. In particular embodiments, third angle 903 plus second angle 902 minus first angle 901, is equal to 90 degrees (i.e., to the nearest degree).

In particular embodiments, a heat exchanger, or a heat exchanger of an HVAC unit (e.g., 130, 161, or both), may be a micro-channel heat exchanger, for instance, and the fins may extend beyond the micro-channels on at least one side of the heat exchanger. In some embodiments, for example, the fins may be wider than the micro-channels, and the fins may extend beyond the micro-channels on one or both sides of the heat exchanger. Having larger fins may promote heat transfer for a given size micro-channel, in some embodiments.

On the other hand, in some embodiments, multiple (e.g., some or all) micro-channels or multi-tubes (e.g., 83 shown in FIG. 8a) may extend beyond the fins (e.g., 85) on at least one side of the heat exchanger, for instance, to promote runoff of condensation along the nose or extending edge (e.g., 86) of the multi-channel (e.g., 83). In a number of embodiments, the micro-channels may be oriented non-horizontally, closer to vertical than to horizontal, substantially vertically, or vertically (e.g., as shown in FIG. 8a), as examples, facilitating flow of condensation which may be attached to the micro-channels (e.g., 83) by surface tension, for instance. In some embodiments (e.g., as shown in FIG. 8a), the micro-channels (e.g., 83) may be wider than the fins (e.g., 85), for instance.

Further, in some embodiments, the micro-channels may extend beyond the fins on both sides of the heat exchanger. In other embodiments, the micro-channels (e.g., 83) may extend beyond the fins (e.g., 85) on just one side (e.g., as shown in FIG. 8a), which may be positioned as the bottom side, in some embodiments, the side where the air leaves the heat exchanger, the side of the downward end of the fins), or a combination thereof, as examples. In some embodiments, the micro-channels may extend beyond the fins on one side and the fins may extend beyond the micro-channels on the other side of the heat exchanger, as other examples. In other embodiments, the micro-channels (e.g., 83) may extend beyond the fins (e.g., 85) on one side and the fins (e.g., 85) and the micro-channels (e.g., 83) may be flush on the other side of the heat exchanger (e.g., 81 shown in FIG. 8a), as another example. In still other embodiments, the micro-channels may be flush (or substantially flush) with the fins on both sides of the heat exchanger FIG. 1 to FIG. 6, FIG. 8, and FIG. 9 show fins 15, 45, 85, and 95 flush (on both sides) with micro-channel or multi-tube 13, for example.

In different embodiments, micro-channels (e.g., 13 or 83), fins (e.g., 15, 45, 85, or 95), or both, may be 16, 20, or 25.4 mm wide, as examples. Further, in different embodiments, micro-channel heat exchangers (e.g., 100 or 1600) may have 1, 2, 3, or 4 rows of micro-channels (e.g., 13 or 83), as examples, which may have 1, 2, 3, or 4 rows of fins (e.g., 15, 45, 85, or 95), as examples. In the drawings, single rows of micro-channels (e.g., 13 or 83) and fins (e.g., 15, 45, 85, or 95) are shown, and single rows of micro-channels (e.g., 13 or 83) and fins (e.g., 15, 45, 85, or 95) may be used in a number of embodiments. Other embodiments, however, may differ.

Various embodiments of the invention include a means for facilitating drainage or run-off of condensation, for example, from a heat exchanger such as an evaporator in an air conditioning unit. Further, some embodiments are heat pumps that include improved micro-channel heat exchangers for both the evaporator (e.g., 30) and condenser (e.g., 161) as well as a means for facilitating drainage or run-off of condensation for each of the evaporator and condenser. Such a means for facilitating drainage or run-off of condensation may include slanted or angled fins, non-horizontal, sloped, substantially vertical, or vertical micro-channels or multi-tubes, or both, as examples. Other examples may be described herein.

In some embodiments, a means for facilitating drainage or run-off of condensation from a heat exchanger may include a first means for facilitating drainage or run-off of condensation from fins (e.g., fins slanted, for instance, downward in the direction of air flow) and a second means for facilitating drainage or run-off of condensation after the condensation leaves the fins (e.g., micro-channels or multi-tubes that are vertical, substantially vertical, at greater than a 45 degree angle from horizontal, non-horizontal, or the like, that extend beyond the fins, or a combination thereof).

Furthermore, besides apparatuses such as heat exchangers (e.g., 10, 40, 80, 81, 90, 100, or 1600), HVAC units (e.g., 130, 161, air conditioning units, or heat pumps), HVAC systems (e.g., 160 shown in FIG. 16), and buildings (e.g., 165), various embodiments include processes or methods, including methods of making, obtaining, providing, and using such apparatuses. A number of embodiments include, or are the result of, for example, a method of making a direct expansion HVAC unit (e.g., 130, 161, or both) using a micro-channel first heat exchanger (e.g., 10, 40, 80, 81, 90, 100, or 1600), for instance, for an evaporator. In a number of embodiments, the method may include, in various sequences, certain acts.

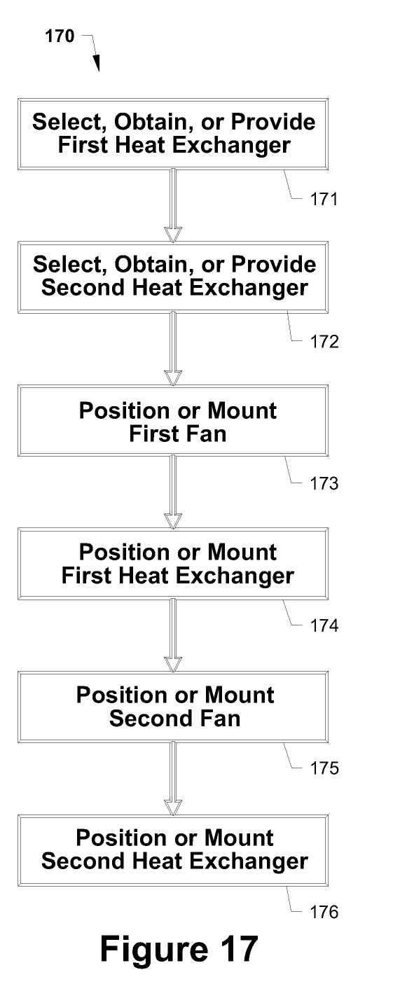

Referring now to FIG. 17, these acts may include, for instance, and method 170 shown specifically includes, an act 171 of selecting a first heat exchanger (e.g., 10, 40, 80, 81, 90, or 100) for use as a first evaporator, for instance. The first heat exchanger (e.g., 10, 40, 80, 81, 90, or 100) may have, for example, various features described herein, such as a first refrigerant header tube (e.g., 11), a second refrigerant header tube (e.g., 102), and multiple multi-tubes (e.g., 13 or 83) extending from the first refrigerant header tube (e.g., 11) to the second refrigerant header tube (e.g., 102). In some embodiments, the multi-tubes (e.g., 13 or 83) may be arranged in parallel to each other with respect to flow of the refrigerant, may have multiple contiguous parallel refrigerant passageways (e.g., 601 to 610 shown in FIG. 6) therethrough, may have multiple fins (e.g., 15, 45, 85, or 95) between the multi-tubes (e.g., 13 or 83), or a combination thereof, for example. In the embodiment illustrated, method 170 further includes act 173 of positioning a first fan (e.g., an evaporator fan, such as fan 142 shown in FIG. 14 and FIG. 15) to move air through the first evaporator (e.g., heat exchanger(s) 100 in a first direction (e.g., direction 96, 97, 98, or a combination thereof, shown in FIG. 9 to FIG. 12 and FIG. 14), for instance.

Further, some embodiments, such as method 170, may include an act 174 of positioning the first evaporator (e.g., heat exchanger 10, 40, 80, 81, 90, or 100) in the HVAC unit (e.g., 130) so that the multi-tubes (e.g., 13 or 83) are not horizontal and so that the fins (e.g., 15, 45, 85, or 95) slant or slope downward (e.g., in the air-flow direction or in the first direction). In some embodiments, the act of positioning (e.g., 174) the first evaporator in the HVAC unit includes positioning the first evaporator (e.g., heat exchanger 10, 40, 80, 81, 90, or 100) so that the multi-tubes (e.g., 13 or 83) are oriented at an angle that is closer to vertical than to horizontal (e.g., as shown in FIG. 9 to FIG. 12 and FIG. 14), so that the multi-tubes (e.g., 13 or 83) are oriented substantially vertically, or so that the multi-tubes (e.g., 13 or 83) are oriented vertically (e.g., as shown in FIG. 1 to FIG. 8a), as examples. Further, in a number of embodiments, act 174 of positioning the first evaporator (e.g., heat exchanger 10, 40, 80, 81, 90, or 100) in the HVAC unit (e.g., 130) includes positioning the first evaporator so that the fins (e.g., 15, 45, 85, or 95) are slanted (e.g., downward in the air-flow direction or in the first direction) at an angle from horizontal that is greater than 5 degrees, greater than 7 degrees, greater than 10 degrees, between 5 degrees and 60 degrees, between 7 degrees and 45 degrees, between 10 degrees and 30 degrees, between 15 degrees and 25 degrees or between 17.5 degrees and 22.5 degrees, as examples.

Still referring to FIG. 17, in some embodiments, act 171 of selecting the first heat exchanger (e.g., 10, 40, 80, 81, 90, or 100) for use as the first evaporator includes selecting a heat exchanger (e.g., 10, 40, 80, 81, 90, or 100) in which multiple of the fins (e.g., 45 or 85) include multiple louvers (e.g., louvers 56 shown in FIG. 4 to FIG. 7). Further, in some embodiments, act 174 of positioning the first heart exchanger or evaporator in the HVAC unit (e.g., 130) includes positioning the first evaporator in the HVAC unit so that the louvers (e.g., louvers 56 shown in FIG. 4 to FIG. 7) are slanted (e.g., downward in the air-flow direction or in the first direction), and in particular embodiments, the louvers (e.g., 56) may be slanted more steeply than the fins (e.g., 45 or 85), for example.

Certain methods may further include act 172 of selecting a second heat exchanger (e.g., 10, 40, 80, 81, 90, 100, or 1600), for instance, for a second evaporator or for a condenser (e.g., for heat exchanger 1600 shown in FIG. 16), for example, for a heat pump. In a number of such embodiments, the second heat exchanger (e.g., 10, 40, 80, 81, 90, 100, or 1600) may have a third refrigerant header tube (e.g., corresponding to or similar to first refrigerant header tube 11), a fourth refrigerant header tube (e.g., corresponding to or similar to second refrigerant header tube 102), and multiple multi-tubes (e.g., corresponding to or similar to multi-tubes 13 or 83) extending from the third refrigerant header tube to the fourth refrigerant header tube, for instance. In certain embodiments, the multi-tubes (e.g., corresponding to or similar to multi-tubes 13 or 83) may be arranged in parallel to each other with respect to flow of the refrigerant, each multi-tube may have multiple contiguous parallel refrigerant passageways (e.g., corresponding to or similar to 601 to 610 shown in FIG. 6) therethrough, there may be multiple fins (e.g., corresponding to or similar to fins 15, 45, 85, or 95) between the multi-tubes, or a combination thereof, as examples.

Particular such embodiments may include additional acts (e.g., act 175) of positioning a second fan (e.g., fan 1650 shown in FIG. 16) to move air through the second heat exchanger (e.g., 1600, which may be similar to heat exchanger 10, 40, 80, 81, 90, or 100) in a second direction, positioning (e.g., act 176) the second heat exchanger (e.g., 1600) in the HVAC unit so that the multi-tubes (e.g., corresponding to or similar to 13 or 83) of the second heat exchanger (e.g., 1600) are not horizontal and so that the fins (e.g., corresponding to or similar to 15, 45, 85, or 95) of the second heat exchanger slant or slope downward (e.g., in the air-flow direction or in the second direction), or a combination thereof, for instance. Further, in some embodiments, act 176 of positioning the second heat exchanger (e.g., 1600) in the HVAC unit (e.g., 161) includes positioning the second heat exchanger (e.g., 1600) in the HVAC unit (e.g., 161) so that the multi-tubes (e.g., corresponding to or similar to 13 or 83) of the second heat exchanger (e.g., 1600) are oriented at an angle that is closer to vertical than to horizontal, are oriented substantially vertically, or are oriented vertically, as examples.

Moreover, in some embodiments, the act 176 of positioning the second heat exchanger (e.g., 1600) in the HVAC unit (e.g., 161) includes positioning the second heat exchanger (e.g., 1600) in the HVAC unit so that the fins (e.g., corresponding to or similar to 15, 45, 85, or 95) of the second heat exchanger (e.g., 1600, similar to heat exchanger 10, 40, 80, 81, 90, or 100) are slanted (e.g., downward in the air-flow direction or in the second direction) at an angle from horizontal that is greater than 5 degrees, greater than 7 degrees, greater than 10 degrees, between 5 degrees and 60 degrees, between 7 degrees and 45 degrees, between 10 degrees and 30 degrees, between 15 degrees and 25 degrees, or between 17.5 degrees and 22.5 degrees, as examples.

Additionally, in some embodiments, act 172 of selecting the second heat exchanger (e.g., 1600) includes selecting a heat exchanger (e.g., corresponding to or similar to 40, 80, or 81) having multiple louvers (e.g., corresponding to or similar to 56) on the fins (e.g., corresponding to or similar to 45 or 85), for instance. In certain embodiments, act 176 of positioning the second heat exchanger (e.g., 1600) in the HVAC unit (e.g., 161) includes positioning the second heat exchanger (e.g., corresponding to or similar to 40, 80, or 81) in the HVAC unit so that the louvers (e.g., corresponding to or similar to 56) of the second heat exchanger are slanted (e.g., downward in the air-flow direction or in the second direction), or are even slanted more steeply than the fins (e.g., corresponding to or similar to 45 or 85) of the second heat exchanger (e.g., 1600), for example.

Referring still to FIG. 17, in particular embodiments, act 171 of selecting the first heat exchanger (e.g., 10, 40, 80, 81, 90, or 100) for use as the first evaporator includes selecting the first heat exchanger (e.g., 10, 40, 80, 81, 90, or 100) such that the multi-tubes (e.g., 13 or 83) are parallel to each other geometrically, for instance. Further, in some embodiments, act 171 of selecting the first heat exchanger (e.g., 10, 40, 80, 81, 90, or 100) for use as the first evaporator includes selecting a heat exchanger for use as the first evaporator in which each multi-tube (e.g., 13 or 83) has multiple contiguous parallel refrigerant passageways (e.g., 601 to 610 shown in FIG. 6) therethrough arranged in at least one row (e.g., 63). Further still, in a number of embodiments, act 171 of selecting the first heat exchanger for use as the first evaporator includes selecting a heat exchanger (e.g., 10, 40, 80, 81, 90, or 100) in which the fins (e.g., 15, 45, 85, or 95) of the heat exchanger are bonded to the multi-tubes (e.g., 13 or 83) of the first heat exchanger (e.g., 10, 40, 80, 81, 90, or 100).

In various embodiments, act 171 of selecting the first heat exchanger (e.g., 10, 40, 80, 81, 90, or 100) for use as the first evaporator includes selecting a heat exchanger for use as the first evaporator wherein the fins (e.g., 15, 45, 85, or 95) are oriented at an angle that is less than 80 degrees, that is less than 75 degrees, that is between 45 and 80 degrees, that is between 60 and 80 degrees, that is between 65 and 75 degrees, or that is between 67.5 and 72.5 degrees from the multi-tubes (e.g., 13 or 83) of the first heat exchanger (e.g., 10, 40, 80, 81, 90, or 100), as examples.

In some embodiments, act 171 of selecting the first heat exchanger (e.g., 10, 40, 80, 81, 90, or 100) for use as the first evaporator includes selecting a first heat exchanger for use as the first evaporator wherein the first refrigerant header tube (e.g., 11) is substantially parallel to the second refrigerant header tube (e.g., 102), wherein the multi-tubes (e.g., 13 or 83) of the first heat exchanger (e.g., 10, 40, 80, 81, 90, or 100) are substantially perpendicular to the first refrigerant header tube (e.g., 11), wherein, the rows (e.g., 63 as shown in FIG. 6) of contiguous passageways (e.g., 601 to 610) are substantially perpendicular to the multi-tubes (e.g., 13 or 83) of the first heat exchanger (e.g., 10, 40, 80, 81, 90, or 100) and the rows (e.g., 63 as shown in FIG. 6) of contiguous passageways (e.g., 601 to 610) are substantially perpendicular to the first refrigerant header tube (e.g., 11), or a combination thereof, as examples.

Other examples of embodiments include various a methods (e.g., 170) of making an HVAC unit (e.g., 130, 161, or both), for instance, having reduced air flow restriction. Some embodiments of such a method have (e.g., in any order or in a particular order) at least certain acts. Such acts may include, for instance, act 171 of obtaining or providing a heat exchanger (e.g., 10, 40, 80, 81, 90, 100, or 1600), such as described herein. Such a heat exchanger (e.g., 10, 40, 80, 81, 90, 100, or 1600) may, for instance, have a third angle (e.g., third angle 903 shown FIG. 9), that is less than 90 degrees, less than 80 degrees, more than 30 degrees, more than 45 degrees, or a combination thereof, as examples. Other examples and ranges for third angle 903 are described herein. In a number of embodiments, the heat exchanger (e.g., 10, 40, 80, 81, 90, 100, or 1600) may have a perpendicular direction (e.g., direction 99 as shown in FIG. 9) that may be, for example, perpendicular to the first header tube (e.g., 11), perpendicular to the second header tube (e.g., 102), perpendicular to the parallel or multi-tubes (e.g., 13 or 83), or a combination thereof, as examples.

In some embodiments, methods (e.g., method 170) may include act 174 of mounting the (e.g., first) heat exchanger (e.g., 10, 40, 80, 81, 90, 100, or 1600) within the HVAC unit (e.g., 130 or 161) in the path of air flow having a predominant air-flow direction (e.g., 96 as shown in FIG. 9) approaching the heat exchanger (e.g., 10, 40, 80, 81, 90, 100, or 1600). As an example, FIG. 10 to FIG. 15 illustrate an example of an HVAC unit or air handler 130 that includes two heat exchangers 100 that are mounted within HVAC unit 130 in the path of air flow having a predominant air-flow direction 96 approaching the heat exchanger 100 that is vertically up. In certain embodiments, act 174 of mounting the heat exchanger (e.g., 10, 40, 80, 81, 90, 100, or 1600) may include positioning the heat exchanger (e.g., 10, 40, 80, 81, 90, 100, or 1600) so that first angle 901 between the predominant air-flow direction 96 approaching the heat exchanger (e.g., 90) and the fins (e.g., 95, as shown in FIG. 9) is less than second angle 902 between the predominant air-flow direction 96 approaching the heat exchanger (e.g., 90) and the perpendicular direction (e.g., 99 as also shown in FIG. 9).

Another embodiment is a method (e.g., 170) of making an

HVAC unit (e.g., 130, 161, or both) having reduced air flow restriction, in which the method includes (e.g., in any order) at least act 171 of obtaining or providing a heat exchanger (e.g., 10, 40, 80, 81, 90, 100, or 1600) having a perpendicular direction (e.g., 99 as shown in FIG. 9), the heat exchanger (e.g., 10, 40, 80, 81, 90, 100, or 1600) having fins (e.g., 15, 45, 85, or 95) oriented at a non-zero fin angle (e.g., 93) to the perpendicular direction (e.g., 99). Various methods described herein may include such an act. As used herein, a non-zero fin angle (e.g., 93) means that the angle between the fin (e.g., 95) and the perpendicular direction (e.g., 99) is more than ½ degree. In some embodiments, this fin angle (e.g., 93) may be more than one degree, more than two degrees, more than three degrees, more than five degrees, more than seven degrees, more than ten degrees, or more than 20 degrees, as other examples. Further examples are described herein.

In a number of embodiments, method 170 also (or instead) includes act 174 of mounting the heat exchanger (e.g., 10, 40, 80, 81, 90, 100, or 1600) within the HVAC unit (e.g., 130 or 161) in the path of air flow having a predominant air-flow direction (e.g., 96 shown in FIG. 9) approaching the heat exchanger (e.g., 90), wherein act 174 of mounting the heat exchanger (e.g., 90) includes positioning the heat exchanger so that first angle 901 between the predominant air-flow direction 96 approaching the heat exchanger (e.g., 90) and the fins (e.g., 95) is less than second angle 902 between the predominant air-flow direction 96 approaching the heat exchanger (e.g., 90) and the perpendicular direction 99.

In particular embodiments, act 174 of mounting the heat exchanger (e.g., 10, 40, 80, 81, 90, 100, or 1600) includes positioning the heat exchanger so that first angle 901 is at least 5 degrees less than second angle 902, at least 10 degrees less than second angle 902, at least 15 degrees less than second angle 902, at least 20 degrees less than second angle 902, at least 25 degrees less than second angle 902, at least 30 degrees less than second angle 902, at least 35 degrees less than second angle 902, at least 40 degrees less than second angle 902, or at least 45 degrees less than second angle 902, as examples. In certain embodiments, act 174 of mounting the heat exchanger (e.g., 10, 40, 80, 81, 90, 100, or 1600) includes positioning the heat exchanger so that first angle 901 is about 47.5 degrees less than second angle 902 or so that first angle 901 is 47.5 degrees less than second angle 902, as other examples. Further, in some embodiments, the act of mounting the heat exchanger (e.g., 10, 40, 80, 81, 90, 100, or 1600) includes positioning the heat exchanger so that first angle 901 is no more than 50 degrees less than second angle 902, no more than 55 degrees less than second angle 902, no more than 60 degrees less than second angle 902, no more than 65 degrees less than second angle 902, or no more than 70 degrees less than second angle 902, as further examples.

In particular embodiments, method 170 shown in FIG. 17 is such that act 174 of mounting the heat exchanger (e.g., 10, 40, 80, 81, 90, 100, or 1600) includes positioning the heat exchanger so that the fins (e.g., 15, 45, 85, or 95) are oriented at a third angle (e.g., third angle 903 shown in FIG. 9) from the parallel tubes or multi-tubes (e.g., 13 or 83), such that third angle 903 plus second angle 902 minus first angle 901, is substantially equal to 90 degrees. Further, in certain embodiments, method 170 may be accomplished such that third angle 903 plus second angle 902 minus first angle 901, is equal to 90 degrees.

In some embodiments, (e.g., within an installed HVAC unit, such as indoor unit 130 shown in FIG. 13 and FIG. 16, outdoor unit 161 shown in FIG. 16, or both) the fins (e.g., 15, 45, 85, or 95) are slanted upward in the air-flow direction (e.g., 97 shown in FIG. 9). In certain embodiments, louvers (e.g., similar to 56 shown in FIG. 4 to FIG. 6) may be slanted upward in the air-flow direction as well (or instead). Further, in some methods (e.g., 170 shown in FIG. 17), the act (e.g., 176) of positioning a second heat exchanger (e.g., 1600) in the HVAC unit (e.g., 161) comprises positioning the heat exchanger (e.g., 1600) so that the fins (e.g., corresponding to or similar to 15, 45, 85, or 95) of the second heat exchanger (e.g., 1600, which may be corresponding to or similar to 10, 40, 80, 81, 90, or 100) are slanted upward in the second direction (e.g., direction 97 shown in FIG. 9). Moreover, in some embodiments, an act (e.g., 174) of positioning an evaporator (e.g. the first evaporator, or heat exchanger 100) in the HVAC unit (e.g., 130) comprises positioning the evaporator so that the fins (e.g., 15, 45, 85, or 95) of the evaporator are slanted upward in the first direction (e.g., 97).

Having the fins (e.g., 15, 45, 85, or 95) slant upward in the air-flow direction (e.g., 97) may not help to promote condensation runoff as well as having the fins (e.g., 15, 45, 85, or 95) slant downward in the air-flow direction. But HVAC units (e.g., the air handler 130, condensing unit 161, or both illustrated in FIG. 16), may be built with the fins (e.g., 15, 45, 85, or 95) slanting upward in the air-flow direction in order to improve air flow or reduce air-flow restriction through the heat exchanger (e.g., 10, 40, 80, 81, 90, 100, or 1600), for example. In some embodiments, it is advantageous to have the predominant air-flow direction (e.g., 96) approaching the heat exchanger (e.g., 1600 as shown in FIG. 16) be upward (e.g., vertical), for instance, to promote upward exhaust of condenser air, for instance. In FIG. 16, the flow of air into and out of condenser or unit 161 (e.g., through heat exchanger 1600) is illustrated by arrows.

For example, air conditioning units that are not also heat pumps may be built with the fins (e.g., corresponding to or similar to 15, 45, 85, or 95) of the condenser (e.g., 1600) slanting upward in the air-flow direction in order to improve air flow or reduce air-flow restriction through the condenser (e.g., 161 or 1600). In such embodiments, condensation does not form in the condenser, so condensation removal is not an issue. In other embodiments, having the fins (e.g., corresponding to or similar to 15, 45, 85, or 95) slope upward in the air-flow direction may be satisfactory because air flow is insufficient to interfere with condensation flow along the fins, or because air flow is so high that having the fins (e.g., corresponding to or similar to 15, 45, 85, or 95) slope downward in the direction of air flow is superfluous. In some embodiments, fins (e.g., 85 or 95) may be sloped (i.e., from horizontal) more steeply if the fins (e.g., 85 or 95) are slanted upwards in the air-flow direction, than the fins (e.g., 15 or 45) would be sloped if sloped downward in the air-flow direction. The greater slope, in such embodiments (e.g., as shown in FIG. 8, FIG. 8a, and FIG. 9), may provide better runoff of condensation to compensate for the direction of the air flow, for instance.

In a number of embodiments, the act (e.g., 171, 172, or both) of obtaining or providing the heat exchanger (e.g., 10, 40, 80, 81, 90, 100, or 1600) comprises obtaining or providing a heat exchanger (e.g., 10, 40, 80, 81, 90, 100, or 1600) having a first header tube (e.g., 11) and a second header tube (e.g., 102), wherein the perpendicular direction (e.g., 99) is perpendicular to the first header tube (e.g., 11), perpendicular to the second header tube (e.g., 102), or both. Further, in some embodiments, the act (e.g., 171 or 172) of obtaining or providing the heat exchanger (e.g., 10, 40, 80, 81, 90, 100, or 1600) comprises obtaining or providing a heat exchanger having multiple parallel tubes (e.g., 13 or 83) extending from the first header tube (e.g., 11) to the second header tube (e.g., 102). In various embodiments, the perpendicular direction (e.g., 99) is perpendicular to these parallel tubes (e.g., 13 or 83). And in certain embodiments, the act (e.g., 171 or 172) of obtaining or providing the heat exchanger (e.g., 10, 40, 80, 81, 90, 100, or 1600) comprises obtaining or providing a heat exchanger having multiple parallel tubes that are multi-tubes (e.g., 13 or 83) and each have multiple parallel fluid passageways (e.g., 601 to 610) therethrough. Further, in some embodiments, the act (e.g., 171 or 172) of obtaining or providing the heat exchanger (e.g., 10, 40, 80, 81, 90, 100, or 1600) comprises obtaining or providing a heat exchanger having multiple multi-tubes (e.g., 13 or 83) that each have multiple contiguous fluid passageways (e.g., 601 to 610) arranged in at least one row (e.g., 63), for instance.

In various embodiments, the act (e.g., 171 or 172) of obtaining or providing the heat exchanger (e.g., 10, 40, 80, 81, 90, 100, or 1600) comprises obtaining or providing a heat exchanger having the fins (e.g., 15, 45, 85, or 95) mounted between the multiple parallel tubes (e.g., 13 or 83). Further, in some embodiments, the act (e.g., 171 or 172) of obtaining or providing the heat exchanger (e.g., 10, 40, 80, 81, 90, 100, or 1600) comprises obtaining or providing a heat exchanger (e.g., 10, 40, 80, 81, 90, 100, or 1600) having a fin angle (e.g., 93) that is at least 5, 10, 15, 20, 25, 30, 35, 40, or 45 degrees, as examples. In particular embodiments, the act (e.g., 171 or 172) of obtaining or providing the heat exchanger (e.g., 10, 40, 80, 81, 90, 100, or 1600) comprises obtaining or specifically providing a heat exchanger having a fin angle that is about 47.5 degrees or having a fin angle (e.g., 93) that is 47.5 degrees, as other examples. In some embodiments, the act (e.g., 171 or 172) of obtaining or providing the heat exchanger (e.g., 10, 40, 80, 81, 90, 100, or 1600) comprises obtaining or providing a heat exchanger having a fin angle (e.g., 93) that is no more than 50, 55, 60, 65, 70, or 75 degrees, for instance. The embodiments shown in FIG. 8 and FIG. 8a have a fin angle (e.g., 93) of 47.5 degrees, for example. Other embodiments may have a fin angle (e.g., 93) of 5, 10, 15, 20 (e.g., as shown in FIG. 1 to FIG. 5), 25, 30, 35, 40, 42.5, 45, 50, 52.5, 55, 60, 65, 70, or 75 degrees, as other examples, or an angle therebetween.

In a number of embodiments, the act (e.g., 174 or 176) of mounting the heat exchanger (e.g., 10, 40, 80, 81, 90, 100, or 1600) includes positioning the heat exchanger so that the fins (e.g., 15, 45, 85, or 95) slope downward in a direction (e.g., 97) of air flow across the fins (e.g., 15, 45, 85, or 95) to promote condensation run off from the fins, while in other embodiments, the act (e.g., 174 or 176) of mounting the heat exchanger (e.g., 10, 40, 80, 81, 90, 100, or 1600) includes positioning the heat exchanger so that the fins (e.g., 15, 45, 85, or 95) slope upward in a direction (e.g., 97) of air flow across the fins.

Other embodiments include methods of obtaining or providing various buildings (e.g., 165 shown in FIG. 16) having one or more HVAC units (e.g., 130, 161, or both) as described herein, for example. In some embodiments, such buildings (e.g., 165) may have a roof (e.g., 163), walls (e.g., 162), an enclosed space (e.g., 166), ductwork (e.g., 167), a controller (e.g., 1610), or a combination thereof, for instance. Various methods may include acts of obtaining or providing such equipment, for example.

As illustrated in FIG. 9, in some embodiments, the HVAC unit may have a predominant air-flow direction 98 after leaving (i.e., after the air leaves) the heat exchanger (e.g., 90). In FIG. 10 to FIG. 12 and FIG. 14, two heat exchangers 100 are shown and a thick arrow labeled “Air Flow”. In this illustration, the predominant air-flow direction 98 after leaving the heat exchanger (e.g., 100) is vertically up. In FIG. 9 the predominant air-flow direction 98 after leaving the heat exchanger (e.g., 90) is also vertically up. As used herein, the predominant air-flow direction (e.g., 98) after leaving the heat exchanger (e.g., 10, 40, 80, 81, 90, 100, or 1600) is not necessarily the air-flow direction immediately after leaving the heat exchanger, but rather, is the air-flow direction after leaving the heat exchanger but before the air is guided by any turning vanes, ductwork, a fan (e.g., 142), or the like. In different embodiments, the predominant air-flow direction (e.g., 98) after leaving the heat exchanger (e.g., 10, 40, 80, 81, 90, 100, or 1600) may be the same direction or a different direction in comparison with the predominant air-flow direction (e.g., 96) approaching the heat exchanger (e.g., 10, 40, 80, 81, 90, 100, or 1600).

For example, as illustrated in FIG. 16, in some condensing units (e.g., 161) on split system air conditioning units or heat pumps, the condenser fan (e.g., 1650) may blow air up (vertically), drawing outside air horizontally through the condenser heat exchanger (e.g., 1600). In such embodiments, the predominant air-flow direction (e.g., 98) after leaving the heat exchanger (e.g., 10, 40, 80, 81, 90, 100, or 1600) is vertical (up), but the predominant air-flow direction (e.g., corresponding to direction 96) approaching the heat exchanger (e.g., 10, 40, 80, 81, 90, 100, or 1600) is horizontal. As used herein, there is no ductwork or turning vanes between the heat exchanger (e.g., 10, 40, 80, 81, 90, 100, or 1600) and the location where the air leaving the heat exchanger (e.g., 10, 40, 80, 81, 90, 100, or 1600) assumes the “predominant air-flow direction after leaving the heat exchanger” (e.g., direction 98).

In a number of embodiments, a fourth angle (e.g., 904) between the predominant air-flow direction (e.g., 98) after leaving the heat exchanger (e.g., 90) and the fins (e.g., 95) is less than a fifth angle (e.g., 905) between the predominant air-flow direction (e.g., 98) after leaving the heat exchanger (e.g., 90) and the perpendicular direction (e.g., 99). In some embodiments, the difference between fourth angle 904 and fifth angle 905 provides benefit at reducing air-flow restriction or improving air flow, for instance.

In various embodiments, fourth angle 904 is at least 5 degrees less than fifth angle 905, at least 10 degrees less than fifth angle 905, at least 15 degrees less than fifth angle 905, at least 20 degrees less than fifth angle 905, at least 25 degrees less than fifth angle 905, at least 30 degrees less than fifth angle 905, at least 35 degrees less than fifth angle 905, at least 40 degrees less than fifth angle 905, or at least 45 degrees less than fifth angle 905, as examples. Further, in some embodiments fourth angle 904 is about 47.5 degrees less than fifth angle 905, or specifically is 47.5 degrees less than fifth angle 905, as examples.

In some embodiments, fourth angle 904 is no more than 50 degrees less than fifth angle 905, fourth angle 904 is no more than 55 degrees less than fifth angle 905, fourth angle 904 is no more than 60 degrees less than fifth angle 905, fourth angle 904 is no more than 65 degrees less than fifth angle 905, fourth angle 904 is no more than 70 degrees less than fifth angle 905, or fourth angle 904 is no more than 75 degrees less than fifth angle 905, as examples. In a number of embodiments, third angle 903 plus fifth angle 905 minus fourth angle 904, is substantially equal to 90 degrees. In fact, in particular embodiments, third angle 903 plus fifth angle 905 minus fourth angle 904, is equal to 90 degrees (i.e., to the nearest degree).

In some embodiments, methods (e.g., 170) may include an act (e.g., 174 or 176) of mounting (e.g., positioning and orienting) the heat exchanger (e.g., 10, 40, 80, 81, 90, 100, or 1600) within the HVAC unit (e.g., 130 or 161) so that air flow will have a predominant air-flow direction (e.g., 98) after leaving the heat exchanger (e.g., 10, 40, 80, 81, 90, 100, or 1600), wherein the act (e.g., 174 or 176) of mounting the heat exchanger includes positioning the heat exchanger (e.g., 10, 40, 80, 81, 90, 100, or 1600) so that fourth angle 904 between the predominant air-flow direction 98 after leaving the heat exchanger (e.g., 10, 40, 80, 81, 90, 100, or 1600) and the fins (e.g., 15, 45, 85, or 95) is less than fifth angle 905 between the predominant air-flow direction 98 after leaving the heat exchanger (e.g., 10, 40, 80, 81, 90, 100, or 1600) and perpendicular direction 99. In certain embodiments, the act (e.g., 174 or 176) of mounting the heat exchanger (e.g., 10, 40, 80, 81, 90, 100, or 1600) may include positioning the heat exchanger so that fourth angle 904 between the predominant air-flow direction 98 after leaving the heat exchanger (e.g., 10, 40, 80, 81, 90, 100, or 1600) and the fins (e.g., 15, 45, 85, or 95) is less than fifth angle 905 between the predominant air-flow direction 98 after leaving the heat exchanger (e.g., 10, 40, 80, 81, 90, 100, or 1600) and perpendicular direction 99.

Another embodiment is a method (e.g., 170) of making an HVAC unit (e.g., 130, 161, or both) having reduced air flow restriction, in which the method includes (e.g., in any order) (or various of the above methods may include) at least the act (e.g., 171 or 172) of obtaining or providing a heat exchanger (e.g., 10, 40, 80, 81, 90, 100, or 1600) having a perpendicular direction (e.g., 99), the heat exchanger (e.g., 10, 40, 80, 81, 90, 100, or 1600) having fins (e.g., 15, 45, 85, or 95) oriented at a non-zero fin angle (e.g., 93) to the perpendicular direction (e.g., 99). Other embodiments may have other fin angles (e.g., 93) described herein, or the fin angle may be within various fin-angle ranges described herein.

In a number of embodiments, this method (e.g., 170) also includes an act (e.g., 174 or 176) of mounting the heat exchanger (e.g., 10, 40, 80, 81, 90, 100, or 1600) within the HVAC unit, wherein the act of mounting the heat exchanger includes positioning the heat exchanger (e.g., 10, 40, 80, 81, 90, 100, or 1600) so that a fourth angle (e.g., 904) between a predominant air-flow direction (e.g., 98) after leaving the heat exchanger (e.g., 10, 40, 80, 81, 90, 100, or 1600) and the fins (e.g., 15, 45, 85, or 95) is less than a fifth angle (e.g., 905) between the predominant air-flow direction (e.g., 98) after leaving the heat exchanger and the perpendicular direction (e.g., 99).

In particular embodiments, the act (e.g., 174 or 176) of mounting the heat exchanger (e.g., 10, 40, 80, 81, 90, 100, or 1600) includes positioning the heat exchanger so that fourth angle 904 is at least 5, 10, 15, 20, 25, 30, 35, 40, or 45 degrees less than fifth angle 905, as examples. In certain embodiments, the act (e.g., 174 or 176) of mounting the heat exchanger (e.g., 10, 40, 80, 81, 90, 100, or 1600) includes positioning the heat exchanger so that fourth angle 904 is about 47.5 degrees less than fifth angle 905 or so that fourth angle 904 is 47.5 degrees less than fifth angle 905, as other examples. Further, in some embodiments, the act (e.g., 174 or 176) of mounting the heat exchanger (e.g., 10, 40, 80, 81, 90, 100, or 1600) includes positioning the heat exchanger so that fourth angle 904 is no more than 50, 55, 60, 65, 70, or 75 degrees less than fifth angle 905, as further examples.

In particular embodiments, method 170 is such that act 174 or 176 of mounting the heat exchanger (e.g., 10, 40, 80, 81, 90, 100, or 1600) includes positioning the heat exchanger so that the fins (e.g., 15, 45, 85, or 95) are oriented at third angle 903 from the parallel tubes or multi-tubes (e.g., 13 or 83), such that third angle 903 plus fifth angle 905 minus fourth angle 904, is substantially equal to 90 degrees. Further, in certain embodiments, third angle 903 plus fifth angle 905 minus fourth angle 904, is equal to 90 degrees.

In a number of embodiments, act 174 or 176 of mounting the heat exchanger (e.g., 10, 40, 80, 81, 90, 100, or 1600) includes positioning the heat exchanger so that the fins (e.g., 15, 45, 85, or 95) slope downward in a direction (e.g., 97) of air flow across the fins, for example, to promote condensation run off from the fins. In other embodiments, on the other hand, act 174 or 176 of mounting the heat exchanger (e.g., 10, 40, 80, 81, 90, 100, or 1600) includes positioning the heat exchanger so that the fins (e.g., 15, 45, 85, or 95) slope upward in a direction (e.g., 97) of air flow across the fins (e.g., as illustrated in FIG. 9).

Various methods described herein include acts of selecting, making, positioning, or using certain components, as examples. Other embodiments may include performing other of these acts on the same or different components, or may include fabricating, assembling, obtaining, providing, ordering, receiving, shipping, or selling such components, or other components described herein or known in the art, as other examples. Further, various embodiments of the invention include various combinations of the components, features, and acts described herein or shown in the drawings, for example.

Certain embodiments of the invention also contemplate various procedures or methods of providing or obtaining different combinations of the components or structure described herein. Such procedures may include acts such as providing or obtaining various components described herein, and providing or obtaining components that perform functions described herein, as well as packaging, advertising, and selling products described herein, for instance. Particular embodiments of the invention also contemplate various means for accomplishing the various functions described herein or apparent from the structure described. Other embodiment include products, such as heat exchangers, HVAC units, air conditioning units, heat exchanger assemblies, and buildings, made, obtained, or provided, in accordance with one or more of the methods described herein. Other embodiments may be apparent to a person of ordinary skill in the art having studied this document.

What is claimed is:

1. An HVAC unit having at least one heat exchanger having a predominant air-flow direction, the heat exchanger comprising a first refrigerant header tube and a second refrigerant header tube, multiple parallel multi-tubes extending from the first refrigerant header tube to the second refrigerant header tube, the multi-tubes being parallel to each other geometrically and arranged in parallel with respect to flow of the refrigerant, each multi-tube having multiple contiguous parallel refrigerant passageways therethrough arranged in at least one row, and wherein each heat exchanger module includes multiple fins between the multi-tubes, wherein the fins are bonded to the multi-tubes; wherein the multi-tubes are oriented non-horizontally in the HVAC unit and the fins are slanted.

2. The HVAC unit of claim 1 wherein the multi-tubes are oriented at an angle that is closer to vertical than to horizontal.

3. The HVAC unit of claim 1 wherein the multi-tubes are oriented substantially vertically.

4. The HVAC unit of claim 1 wherein multiple of the fins comprise multiple louvers, wherein the louvers are slanted.

5. The HVAC unit of claim 1 wherein the HVAC unit comprises at least two heat exchangers, each heat exchanger comprising a first refrigerant header tube and a second refrigerant header tube, multiple parallel multi-tubes extending from the first refrigerant header tube to the second refrigerant header tube, the multi-tubes being parallel to each other geometrically and arranged in parallel with respect to the flow of the refrigerant, each multi-tube having multiple contiguous parallel refrigerant passageways therethrough arranged in at least one row.

6. The HVAC unit of claim 1 wherein the HVAC unit is a heat pump.

7. The HVAC unit of claim 1 wherein the fins are slanted downward in the air-flow direction to promote condensation run off from the fins.

8. The heat exchanger of claim 1 wherein multiple of the multi-tubes extend beyond the fins on at least one side of the heat exchanger to promote runoff of condensation.

9. A building comprising the HVAC unit of claim 1.

10. A heat exchanger for transferring heat from air to a working fluid, wherein the air may contain moisture, the heat exchanger comprising:
a first working fluid header tube;
a second working fluid header tube;
multiple parallel multi-tubes extending from the first working fluid header tube to the second working fluid header tube, the multi-tubes being parallel to each other geometrically and arranged in parallel with respect to flow of the working fluid, each multi-tube having multiple contiguous parallel working fluid passageways therethrough arranged in at least one row;
multiple fins between the multi-tubes, wherein the fins are bonded to the multi-tubes; wherein the fins are oriented at an angle between 45 and 80 degrees from the multi-tubes.

11. An HVAC unit comprising the heat exchanger of claim 10, the HVAC unit having a predominant air-flow direction approaching the heat exchanger, the heat exchanger having a perpendicular direction that is perpendicular to the first header tube, perpendicular to the second header tube, and perpendicular to the multi-tubes, wherein a first angle between the predominant air-flow direction approaching the heat exchanger and the fins is less than a second angle between the predominant air-flow direction approaching the heat exchanger and the perpendicular direction.

12. The HVAC unit of claim 11 wherein the fins are oriented at a third angle from the multi-tubes, wherein the third angle plus the second angle minus the first angle, is substantially equal to 90 degrees.

13. An HVAC unit comprising the heat exchanger of claim 10, the HVAC unit having a predominant air-flow direction after leaving the heat exchanger, the heat exchanger having a perpendicular direction that is perpendicular to the first header tube, perpendicular to the second header tube, and perpendicular to the multi-tubes, wherein a fourth angle between the predominant air-flow direction after leaving the heat exchanger and the fins is less than a fifth angle between the predominant air-flow direction after leaving the heat exchanger and the perpendicular direction.

14. A method of making an HVAC unit having reduced air flow restriction, the method comprising in any order at least the acts of:
obtaining or providing a heat exchanger having a perpendicular direction, the heat exchanger having fins oriented at a non-zero fin angle to the perpendicular direction;
mounting the heat exchanger within the HVAC unit in the path of air flow having a predominant air-flow direction approaching the heat exchanger, wherein the act of mounting the heat exchanger includes positioning the heat exchanger so that a first angle between the predominant air-flow direction approaching the heat exchanger and the fins is less than a second angle between the predominant air-flow direction approaching the heat exchanger and the perpendicular direction.

15. The method of claim 14 wherein the act of obtaining or providing the heat exchanger comprises obtaining or providing a heat exchanger having a first header tube and a second header tube, wherein the perpendicular direction is perpendicular to the first header tube and perpendicular to the second header tube.

16. The method of claim 15 wherein the act of obtaining or providing the heat exchanger comprises obtaining or providing a heat exchanger having multiple parallel tubes extending from the first header tube to the second header tube, wherein the perpendicular direction is perpendicular to the parallel tubes.

17. The method of claim 15 wherein the act of obtaining or providing the heat exchanger comprises obtaining or providing a heat exchanger having multiple parallel tubes that are multi-tubes, that each have multiple parallel fluid passageways therethrough, that each have multiple contiguous fluid passageways arranged in at least one row, and that comprise fins mounted between the multiple parallel tubes.

18. The method of claim 14 wherein the act of obtaining or providing the heat exchanger comprises obtaining or providing a heat exchanger having a fin angle that is at least 20 degrees.

19. The method of claim 14 wherein the act of mounting the heat exchanger includes positioning the heat exchanger so that the first angle is at least 15 degrees less than the second angle.

20. The method of claim 14 wherein the act of mounting the heat exchanger includes positioning the heat exchanger so that the fin angle plus the first angle is substantially equal to the second angle.

21. The method of claim 14 wherein the act of mounting the heat exchanger includes positioning the heat exchanger so that a fourth angle between a predominant air-flow direction after leaving the heat exchanger and the fins is less than a fifth angle between the predominant air-flow direction after leaving the heat exchanger and the perpendicular direction.
